(19) United States
(12) Patent Application Publication
(10) Pub. No.: US 2025/0016641 A1
(43) Pub. Date: Jan. 9, 2025

(54) METHOD AND APPARATUS FOR HANDLING LOWER LAYER TRIGGERED MOBILITY IN A WIRELESS COMMUNICATION SYSTEM

(71) Applicant: SAMSUNG ELECTRONICS CO., LTD., Suwon-si (KR)

(72) Inventors: Aby Kanneath ABRAHAM, Bangalor (IN); Vinay Kumar SHRIVASTAVA, Bangalor (IN); Sriganesh RAJENDRAN, Bangalor (IN)

(21) Appl. No.: 18/766,526

(22) Filed: Jul. 8, 2024

(30) Foreign Application Priority Data
Jul. 8, 2023 (IN) 202341046001
Sep. 7, 2023 (IN) 202341060260
Jun. 27, 2024 (IN) 202341046001

(51) Int. Cl. H04W 36/08; H04W 36/00

(52) U.S. Cl. CPC H04W 36/08; H04W 36/0055

(57) ABSTRACT

The disclosure relates to a 5G or 6G communication system for supporting a higher data transmission rate. Embodiments herein are to provide a method and system for handling lower triggered mobility (LTM) of a base station. The method includes determining whether to configure lower layer triggered mobility (LTM) for a master cell group (MCG); determining whether to configure the LTM for a secondary cell group (SCG); transmitting, to a user equipment (UE), a configuration message including at least one of first LTM configuration information for the MCG and second LTM configuration information for the SCG, wherein the configuration message includes information about at least one channel state information (CSI) resource for configuring at least one candidate cell for the LTM.

### CROSS REFERENCE TO RELATED APPLICATIONS

This application is based on and claims priority under 35 U.S.C. § 119 to Indian Provisional Patent Application No. 202341046001, filed on Jul. 8, 2023, Indian Provisional Patent Application No. 202341060260, filed on Sep. 7, 2023, and Indian Complete Patent Application No. 202341046001, filed on Jun. 27, 2024, in the Indian Intellectual Property Office, the disclosures of which are incorporated herein by reference.

### BACKGROUND

### 1. Field

The present disclosure is related to wireless communication networks. More particularly, the present disclosure is related to a method and system for handling lower layer triggered mobility (LTM) of a next generation radio access network (NG-RAN).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

In one aspect, the objectives are achieved by providing a method for handling lower layer triggered mobility (LTM) of a next generation radio access network (NG-RAN). The method includes determining, by a network apparatus, whether to configure LTM for a master cell group (MCG) of the network apparatus. Further, the method includes determining, by the network apparatus, whether at least one of an access stratum (AS) security configurations associated with at least one master cell of the MCG is activated, and a signalling radio bearer2 (SRB2) with at least one data radio bearer (DRB) is not suspended. The method includes performing one of: transmitting, by the network apparatus, a radio resource control (RRC) reconfiguration message to a user equipment (UE) by including an LTM configuration for the MCG, when the AS security configurations is activated, and the SRB2 with the at least one DRB is not suspended, and transmitting, by the network apparatus, the RRC reconfiguration message to the UE without including the LTM configuration for the MCG, when the AS security configurations is not activated, or the SRB2 with the at least one DRB is suspended.

In an embodiment, the LTM configuration comprises a reference configuration, a reference signal configuration, a configuration for controlling one or more candidate cells for resetting a layer 2 of the LTM during LTM cell switch execution, random access resources, a group of channel state information (CSI) resources for configuring one or more candidate cells for LTM, and a configuration related to transmission configuration indication (TCI) states of the one or more candidate cells.

In an embodiment, the method includes determining, by the network apparatus, whether to configure the LTM for a secondary cell group (SCG) of the network apparatus. Further, the method includes determining, by the network apparatus, whether at least one radio link control (RLC) bearer is setup in the SCG. The method includes performing one of: transmitting, by the network apparatus, the RRC reconfiguration message to the UE by including the LTM configuration for the SCG, when the at least one RLC bearer is setup in the SCG, and transmitting, by the network apparatus, the RRC reconfiguration message to the UE without including the LTM configuration for the SCG, when the at least one RLC bearer is not setup in the SCG.

In an embodiment, the LTM configuration comprises a reference configuration, a reference signal configuration, a configuration for controlling one or more candidate cells for resetting a layer 2 of the LTM during LTM cell switch execution, random access resources, a group of channel state information (CSI) resources for configuring one or more candidate cells for LTM, and a configuration related to transmission configuration indication (TCI) states of the one or more candidate cells.

In an embodiment, the method includes performing, by the network apparatus, an LTM configuration release procedure when the LTM configuration is included in the RRC reconfiguration message. The LTM configuration release procedure comprises configuring a layer 1 of the LTM to be in accordance with the configuration information included in the RRC reconfiguration message.

In one aspect, the objectives are achieved by providing a method for handling lower layer triggered mobility (LTM) of a next generation radio access network (NG-RAN). The method includes receiving, by a user equipment, an LTM configuration in a radio resource control (RRC) reconfiguration message. Further, the method includes receiving, by the UE, an LTM cell switch command downlink (DL) medium access control (MAC) control element (CE) configuration from a network apparatus. The DL MAC CE provides instructions to switch from a source cell to an LTM candidate cell for a master cell group (MCG) or a secondary cell group (SCG). Further, the method includes determining, by the UE, a timing advance (TA) and transmission configuration indication (TCI) states received in the DL MAC CE. Further, the method includes transmitting, by a MAC entity in the UE to an RRC entity in the UE, information that the LTM cell switch command is received. Further, the method includes receiving, by the MAC entity in the UE, instructions from the RRC entity in the UE to reset the UE. Further, the method includes applying, by the MAC entity in the UE, the TA and TCI states determined in the DL MAC CE after the MAC reset. In addition, the method includes transmitting, by the UE, an acknowledgement message to the network apparatus upon receiving the LTM cell switch command.

In an embodiment, receiving, by the UE, the LTM configuration from the network apparatus includes determining whether at least one of an AS security configurations associated with at least one master cell of the MCG is activated, and a signalling radio bearer2 (SRB2) with at least one data radio bearer (DRB) is not suspended. In addition, the method includes receiving, by the UE, the LTM configuration for MCG when the AS security configurations is activated, and the SRB2 with the at least one DRB is not suspended.

In an embodiment, receiving, by the UE, the LTM configuration from the network apparatus includes determining whether at least one RLC bearer is setup in the SCG. In addition, the method includes receiving, by the UE, the LTM configuration for SCG when the at least one RLC bearer is setup in the SCG.

In an embodiment, the method includes detecting, by the UE, a cell switch failure within at least one primary cell of one or more primary cells (PCells) of the MCG. Further, the method includes performing, by the UE, a cell selection process. Further, the method includes performing one of: performing, by the UE, a RACH-based LTM cell switch operation and transmitting an RRC reconfiguration complete message to the network apparatus when a selected cell is an LTM candidate cell for the MCG, and transmitting, by the UE, an RRC reestablishment message to the network apparatus when the selected cell is an LTM candidate cell for the SCG.

In one aspect, the objectives are achieved by providing a network apparatus for handling lower layer triggered mobility (LTM) of a next generation radio access network (NG-RAN). The network apparatus includes a memory, a processor coupled to the memory, and an LTM controller communicatively coupled to the memory and the processor. The LTM controller determines whether to configure the LTM for a master cell group (MCG) of the network apparatus. Further, the LTM controller determines whether at least one of an AS security configurations associated with at least one master cell of the MCG is activated, and a signalling radio bearer2 (SRB2) with at least one data radio bearers (DRB) is not suspended. The LTM controller performs one of: transmits a RRC) reconfiguration message to a user equipment (UE) by including an LTM configuration for the MCG, when the AS security configurations is activated, and the SRB2 with the at least one DRB is not suspended, and transmits the RRC reconfiguration message to the UE without including the LTM configuration for the MCG, when the AS security configurations is not activated, or the SRB2 with the at least one DRB is not suspended.

In an embodiment, the LTM configuration comprises a reference configuration, a reference signal configuration, a configuration for controlling one or more candidate cells for resetting a layer 2 of the LTM during LTM cell switch execution, random access resources, a group of channel state information (CSI) resources for configuring one or more candidate cells for LTM, and a configuration related to transmission configuration indication (TCI) states of the one or more candidate cells.

In an embodiment, the LTM controller determines whether to configure the LTM for a secondary cell group (SCG) of the network apparatus. Further, the LTM controller determines whether at least one RLC bearer is setup in the SCG. Further, the LTM controller performs one of: transmits the RRC reconfiguration message to the UE by including the LTM configuration for the SCG, when the at least one RLC bearer is setup in the SCG, and transmits the RRC reconfiguration message to the UE without including the LTM configuration for the SCG, when the at least one RLC bearer is not setup in the SCG.

In an embodiment, the LTM controller includes a reference configuration, a reference signal configuration, a configuration for controlling one or more candidate cells for resetting a layer 2 of the LTM during LTM cell switch execution, random access resources, a group of channel state information (CSI) resources for configuring one or more candidate cells for LTM, and a configuration related to transmission configuration indication (TCI) states of the one or more candidate cells.

In an embodiment, the LTM controller performs an LTM configuration release procedure when the LTM configuration is included in the RRC reconfiguration message. The LTM configuration release procedure comprises configuring a layer 1 of the LTM to be in accordance with the configuration information included in the RRC reconfiguration message.

In one aspect, the objectives are achieved by providing a user equipment (UE) for handling lower layer triggered mobility (LTM) of a next generation radio access network (NG-RAN). The UE includes a memory, a processor coupled to the memory, and a UE controller communicatively coupled to the memory and the processor. The UE controller receives an LTM configuration in a radio resource control (RRC) reconfiguration message. The UE controller receives an LTM cell switch command DL medium access control (MAC) control element (CE) from a network apparatus, wherein the DL MAC CE provides instructions to switch from a source cell to an LTM candidate cell for a master cell group (MCG) or a secondary cell group (SCG). Further, the UE controller determines a timing advance (TA) and transmission configuration indication (TCI) states received in the DL MAC CE. Further, the UE controller transmits, to an RRC entity in the UE, information that the LTM cell switch command is. Further, the UE controller receives instructions from the RRC entity in the UE to reset the UE. Further, the UE controller applies the TA and TCI states determined in the DL MAC CE after the MAC reset. In addition, the UE controller transmits an acknowledgement message to the network apparatus upon receiving the LTM cell switch command. In NR, the acknowledgement message is RRCReconfigurationComplete.

In an embodiment, the UE controller determines whether at least one of a AS security configurations associated with at least one master cell of the MCG is activated, and a signalling radio bearer2 (SRB2) with at least one data radio bearers (DRB) is not suspended. In addition, the UE controller receives the LTM configuration when the AS security configurations is activated, and the SRB2 with the at least one DRB is not suspended.

In an embodiment, the UE controller determines whether at least one RLC bearer is setup in the SCG. In addition, the UE controller receives the LTM configuration when the at least one RLC bearer is setup in the SCG.

In an embodiment, the UE controller detects a cell switch failure within at least one primary cell of one or more primary cells (PCells) of the MCG. Further, the UE controller performs a cell selection process. The UE controller further performs one of: performs a RACH-based LTM cell switch operation, transmits an RRC reconfiguration complete message to the network apparatus when a selected cell is an LTM candidate cell for the MCG, and transmits an RRC reestablishment message to the network apparatus when the selected cell is a LTM candidate cell for the SCG.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings in which:

FIG. 1 illustrates a block diagram of an overall architecture of NG-RAN;

FIG. 2 illustrates a sequence diagram of a signaling procedure for lower layer triggered mobility (LTM);

FIG. 3 illustrates a block diagram of a radio protocol stack;

FIG. 4 illustrates a block diagram of a user plane protocol stack;

FIG. 5 illustrates a block diagram of a MAC structure with two MAC entities;

FIG. 6 illustrates a block diagram of a MAC structure with two MAC entities;

FIG. 7A illustrates a block diagram of a schematic of a network apparatus implemented to carry out the disclosed subject matter according to embodiments as disclosed herein;

FIG. 7B illustrates a block diagram of a schematic of a user equipment (UE) implemented to carry out the disclosed subject matter according to embodiments as disclosed herein;

FIG. 8 illustrates a flow diagram of a method for LTM configuration in MCG according to embodiments as disclosed herein;

FIG. 9 illustrates a flow diagram of a method for LTM configuration in SCG according to embodiments as disclosed herein;

FIG. 10 illustrates a flow diagram of a method for handling of LTM configuration set as a setup according to embodiments as disclosed herein;

FIG. 11 illustrates a flow diagram of a method for handling of LTM configuration set as a release according to embodiments as disclosed herein;

FIG. 12 illustrates a flow diagram of a method for cell switch failure handling according to embodiments as disclosed herein;

FIG. 13 illustrates a flow diagram of a method for SpCellConfigCommon configuration for an LTM candidate cell which is a serving cell-2 according to embodiments as disclosed herein;

FIG. 14 illustrates a flow diagram of a method for CellGroupConfig configuration for an LTM candidate cell which is a serving cell according to embodiments as disclosed herein;

FIG. 15 illustrates a flow diagram of a method for ltm-CandidateConfig-r18 configuration according to embodiments as disclosed herein;

FIG. 16 illustrates a flow diagram of a method for handling LTM of an NG-RAN, according to embodiments as disclosed herein;

FIG. 17 illustrates a flow diagram of a method for determining AS security configurations, SRB2, and DRB in a LTM configuration received, according to embodiments as disclosed herein;

FIG. 18 illustrates a flow diagram of a method for determining RLC bearers in the LTM configuration received, according to embodiments as disclosed herein; and

FIG. 19 illustrates a flow diagram of a method for detecting a cell switch failure, according to embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimensions of some of the elements in the drawing may be exaggerated relative to other elements to help improve the understanding of aspects of the invention. Furthermore, the elements may have been represented in the drawing by conventional symbols, and the drawings may show only those specific details that are pertinent to the understanding of the embodiments of the invention so as not to obscure the drawing with details that will be readily apparent to those of ordinary skill in the art having the benefit of the description herein.

### DETAILED DESCRIPTION

3GPP specifications such as TS38.300, TS38.331, and TS 38.321 V17.40 are considered as background for the invention.

The evolution of mobile network technology has necessitated the development of advanced infrastructures like the Next Generation Radio Access Network (NG-RAN), a fundamental component of 5G mobile network architecture. NG-RAN is engineered to support the enhanced capabilities and performance requirements of 5G technology, offering significantly higher data rates and lower latency compared to previous generations. These improvements are crucial for enabling high-speed applications and real-time services, which are becoming increasingly prevalent in today's digital landscape.

One of the standout features of NG-RAN is its support for network slicing. This allows network operators to create multiple virtual networks within a single physical network infrastructure, with each slice tailored to meet specific service requirements. This flexibility is essential for optimizing network resources and ensuring that diverse applications can coexist efficiently on the same network.

Conventionally, devices may travel across multiple cells in wireless technologies like 5G NR. In RRC_IDLE mode, mobility is accomplished using a process known as cell reselection. Mobility is carried out using a process known as handover in RRC_CONNECTED mode up to NR R17. On UEs in RRC_CONNECTED, network-controlled mobility is applicable. For a gNB in NR to initiate explicit RRC signaling, this is necessary. In NR, the handover process typically includes three stages: preparation, execution, and completion. The gNB can set up a UE to provide measurements. Then the gNB may send an RRC Reconfiguration message to transfer the UE from the source cell to the destination cell depending on the measurements that are reported or on its own perception of the network topology. The UE accesses the target cell and sends an RRC Reconfiguration complete message.

A different method was introduced in 3GPP NR version 16 whereby a gNB may configure a UE with the execution conditions to initiate handover. The UE may then relocate to the destination cell and transmit the RRC Reconfiguration complete once the execution requirements are met. In version 16, 3GPP also unveiled a brand-new handover known as the DAPS handover. Layer 3 (RRC) signals are sent by the UE during handover in all of these techniques, which results in significant delay and signaling cost. Layer 3 mobility is what this disclosure may refer to as the handover and conditional handover (CHO). In case of dual connectivity, the UE may perform PSCellChange or Conditional PSCellChange. In the context of dual connectivity, this disclosure may refer to PSCellChange or Conditional PSCellChange also as layer 3 mobility, i.e., Handover, Conditional Handover, PSCellChange, Conditional PSCellChange, etc., refers to L3 mobility. This disclosure may also refer to PSCellChange or Conditional PSCellChange as SCG layer 3 mobility and the handover and CHO as MCG layer 3 mobility in the context of dual connectivity.

In wireless technologies like 5G NR, devices can move across different cells. Mobility is performed using a procedure called cell reselection in RRC_IDLE mode. Up to NR R17, mobility is performed using a procedure called handover in RRC_CONNECTED mode. Network-controlled mobility applies to UEs in RRC_CONNECTED. It requires explicit RRC signaling to be triggered by a gNB in NR. In NR, the handover process typically includes three stages: preparation, execution, and completion. The gNB may set up a UE to provide measurements. Then the gNB will send an RRC Reconfiguration message to transfer the UE from the source cell to the destination cell depending on the measurements that are reported or on its own perception of the network topology. The destination cell is accessed by the UE, which then transmits the whole RRC Reconfiguration message. A different method was introduced in 3GPP NR version 16 whereby a gNB may configure a UE with the execution conditions to initiate handover. The UE may then relocate to the destination cell and transmit the RRC Reconfiguration complete once the execution requirements are met. 3GPP also introduced a new handover called DAPS handover in release 16.

In all these methods, the UE performs handover by sending layer 3 (RRC) messages, which causes considerable signaling overhead and latency issues. Mobility at Layer 3 can be referred to as handover and conditional handover (CHO). The UE may execute Conditional PSCell Change or PSCell Change in the event of dual connection. PSCell Change, Conditional PSCell Change, Handover, Conditional Handover, PSCell Change, Conditional PSCell Change, etc., are examples of L3 mobility in the context of dual connectivity. In the context of dual connectivity, PSCell Change or conditional PSCell Change can alternatively be referred to as SCG layer 3 mobility, and the handover and CHO as MCG layer 3 mobility.

However, the introduction of NG-RAN and its associated technologies brings with it a set of new challenges and complexities, particularly in the context of mobility management and security. For instance, in New Radio (NR) technology, the Medium Access Control (MAC) reset is typically triggered by upper layers such as the Radio Resource Control (RRC) during events like handovers. In the context of Layer 2 Mobility (i.e., lower layer triggered mobility (LTM)), the network informs the cell switch directly to the MAC layer, allowing the MAC to perform the reset without inputs from the User Equipment (UE) RRC. This can lead to issues when the UE completes LTM after a failure, necessitating specific solutions for RRC-MAC interactions. The MAC reset in this scenario is performed per cell group, adding another layer of complexity.

Moreover, the timing of LTM measurement configurations relative to Access Stratum (AS) security activation poses additional challenges. If UE performs measurements before AS security activation, it can facilitate quicker handovers. However, this also introduces security vulnerabilities, such as the risk of a malicious UE causing a denial of service attack on another UE through a man-in-the-middle attack. Ensuring that handovers are based on secure, uncorrupted measurements is vital. Similarly, configuring Data Radio Bearers (DRBs) before AS security activation can expose the network to attacks by fake base stations. In case of secondary cell group in dual connectivity, providing the configuration related to LTM early may help the UE to at least start measurements early. On the other hand, this will result in re-preparation of LTM candidate cells, especially if the configuration is provided before a RLC bearer is established. Hence, there are trade-offs concerning when to configure measurements and when to execute mobility actions.

The introduction of LTM also brings a new paradigm for mobility, incorporating a range of additional parameters not present in traditional mobility configurations. For example, LTM configurations include parameters for reference signal configuration, L2 reset control, and others, which need to be clearly defined and managed. These parameters must be considered separately from LTM candidate configurations, requiring precise conditions for their application based on various thresholds.

Furthermore, the UE is permitted to defer the evaluation of LTM candidate cells until the execution of the LTM cell switch, creating a need for specific information to be available beforehand. This necessitates a well-defined framework for determining when to apply different parts of the LTM configuration, ensuring seamless and secure mobility management.

Hence, while NG-RAN and its associated technologies offer substantial advancements in network performance and flexibility, they also introduce a range of technical challenges that need to be addressed. Effective solutions are required to manage the complexities of MAC resets, secure measurement configurations, and the integration of new LTM parameters to ensure robust and reliable 5G network operations.

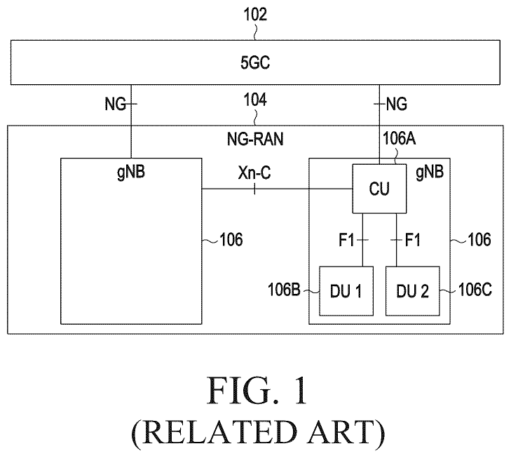

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein refers to a non-exclusive “or” unless otherwise indicated. The examples used herein are intended merely to facilitate an understanding of ways in which the embodiments herein can be practiced and to further enable those skilled in the art to practice the embodiments herein. Accordingly, the examples are not to be construed as limiting the scope of the embodiments herein.

As is traditional in the field, embodiments are described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in one or more semiconductor chips or on substrate supports such as printed circuit boards and the like. The circuits constituting a block be implemented by dedicated hardware or by a processor (e.g., one or more programmed microprocessors and associated circuitry) or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features, and it is understood that the embodiments presented herein are not limited by the accompanying drawings. As such, the proposed method is construed to extend to any alterations, equivalents, and substitutes in addition to those which are particularly set out in the accompanying drawings. Although the terms first, second, etc. are used herein to describe various elements, these elements are not to be limited by these terms. These terms are generally used to distinguish one element from another.

An object of the embodiments herein is to disclose methods and systems for handling Lower-Layer Triggered Mobility (LTM) in a Radio Resource Control (RRC) layer.

Another object of the embodiments herein is to provide RRC and MAC operations for LTM.

Yet another object of the embodiments herein is to provide RRC-MAC interactions during LTM cell switch execution, including the invoking of MAC reset. The MAC reset may be performed per cell group.

Yet another object of the embodiments herein is to provide a UE MAC that informs UE RRC that it has received an LTM cell switch command.

Yet another object of the embodiments herein is to provide UE RRC that informs UE MAC to perform a MAC reset.

Yet another object of the embodiments herein is to provide UE MAC that applies the received timing advance from the LTM cell switch command after the MAC reset.

Yet another object of the embodiments herein is to allow the network system to configure reference configuration, configuration for measurements such as reference signal configuration, configuration for controlling L2 reset, etc., for MCG after AS security is activated and SRB2 and at least one DRB are activated.

Yet another object of the embodiments herein is to allow the network system to configure reference configuration, configuration for measurements such as reference signal configuration, configuration for controlling L2 reset, etc., for SCG after at least one RLC bearer is set up in SCG.

Yet another object of the embodiments herein is to provide a UE that applies a part of LTM configuration at the time of reception of LTM configuration and a part at the time of cell switch.

FIG. 1 illustrates a block diagram of an overall architecture of NG-RAN (104). For instance, the architecture of the NG-RAN (104) may be from TS 38.401. As shown, the NG-RAN (104) includes a 5GC (102) and a set of next-generation node B (gNBs) (106). The gNBs (106) may include a gNB-CU (106A) and one or more gNB-DU(s) (106B). The gNB-CU (106A) and the gNB-DUs (106B) may be connected via an F1 interface. The set of gNBs (106) may be connected to the 5GC (102) through an NG interface and may be interconnected through an Xn interface. Further, the gNB-DU(s) (106B) handle real-time baseband processing, and the gNB-CU (106A) handles non-real-time processing and control functions.

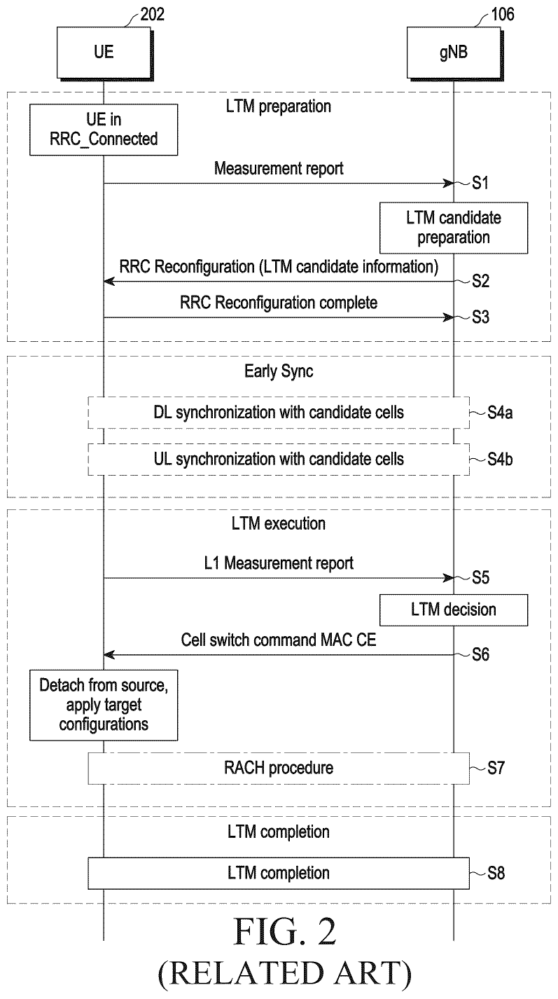

FIG. 2 illustrates a sequence diagram of a signaling procedure for lower layer triggered mobility (LTM). As shown, a user equipment (UE) (202) is in communication with the gNB (106). The signaling procedure ensures that the UE (202) maintains seamless connectivity as it moves. The signaling procedure may be divided into four phases, which are LTM preparation, early sync, LTM execution, and LTM completion.

At step S1, the UE (202) sends a measurement report message to the gNB (106). The gNB (106) decides to configure LTM and initiates candidate cell(s) preparation. At step S2, the gNB (106) transmits a radio resource control (RRC) Reconfiguration message to the UE (202). The RRC Reconfiguration message may include the LTM candidate cell configurations of one or multiple candidate cells. At step S3, the UE (202) stores the LTM candidate cell configurations and transmits an RRC Reconfiguration Complete message to the gNB (106). Steps S1-S3 are performed in the LTM preparation phase of the signaling procedure.

At step S4a, the UE (202) may perform DL synchronization with candidate cell(s) before receiving the cell switch command. At step S4b, the UE (202) performs early TA acquisition with candidate cell(s) requested by the network before receiving the cell switch command. This is done via CFRA triggered by a PDCCH order from the source cell, following which the UE (202) sends a preamble towards the indicated candidate cell. In order to minimize the data interruption of the source cell due to CFRA towards the candidate cell(s), the UE (202) doesn't receive RAR for the purpose of TA value acquisition, and the TA value of the candidate cell is indicated in the cell switch command. The UE (202) doesn't maintain the TA timer for the candidate cell and relies on network implementation to guarantee the TA validity. Steps S4a and S4b are performed in the early sync phase of the signaling procedure.

At step S5, the UE (202) performs L1 measurements on the configured candidate cell(s) and transmits lower-layer measurement reports to the gNB (106). L1 measurement may be performed as long as the RRC reconfiguration is applied in step S2. At step S6, the gNB (106) decides to execute a cell switch to a target cell and transmits a MAC CE triggering cell switch by including the candidate configuration index of the target cell. The UE (202) switches to the target cell and applies the configuration indicated by the candidate configuration index. At step S7, the UE (202) performs the random access procedure towards the target cell if the UE (202) does not have a valid TA of the target cell. Steps S5-S7 may be performed in the LTM execution phase of the signaling procedure.

At step S8, the UE (202) completes the LTM cell switch procedure by sending an RRCReconfigurationComplete message to the target cell. If the UE (202) has performed an RA procedure in step S7, the UE (202) considers that LTM execution is successfully completed when the random access procedure is successfully completed. For RACH-less LTM, the UE (202) considers that LTM execution is successfully completed when the UE (202) determines that the network has successfully received its first UL data.

The steps S4-S8 may be performed multiple times for subsequent LTM cell switches using the LTM candidate cell configuration(s) provided in step A2. Based on known prior arts, a network configures Lower-Layer Triggered Mobility (LTM) candidate cell configurations, LTM reference configuration, and LTM measurement configuration only after Access Stratum (AS) security is activated. It is also known that the network configures LTM candidate cell configurations, LTM reference configuration, and LTM measurement configuration only after AS security is activated and Signaling Radio Bearer2 (SRB2) with at least one Data Radio Bearer (DRB) is set up and not suspended. However, it is not known how the network applies other information elements related to LTM, which may include more static information like the flag/list which controls the L2 reset or the Transmission Configuration Indicator (TCI) states or the CS resource configuration.

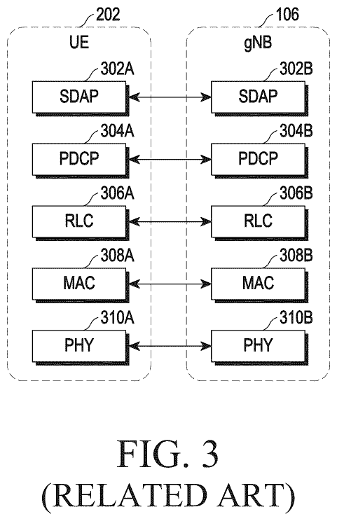

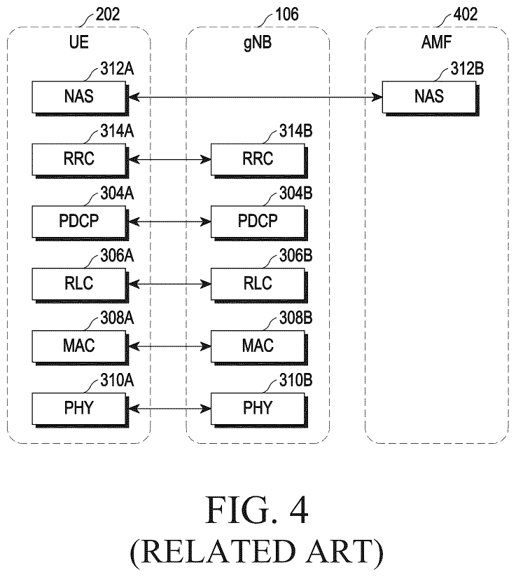

FIG. 3 illustrates a block diagram of a radio protocol stack. The radio protocol stack includes the UE (202) in communication with the gNB (106). The UE (202) and the gNB (106) both may include service data application protocol layers (SDAP) (302A, 302B), packet data convergence protocol layers (PDCP) (304A, 304B), radio link control layers (RLC) (306A, 306B), medium access control layers (MAC) (308A, 308B), and physical layers (PHY) (310A, 310B). Further, FIG. 4 illustrates a block diagram of a user plane protocol stack. Here, the stack includes non-access stratum layers (NAS) (312A, 312B) on the UE (202) and an Access and Mobility Management Function (AMF) device (402) and radio resource controls (RRC) (314A, 314B) on the UE (202) and the gNB (106).

The PDCP (304A, 304B), the RLC (314A, 314B), and the MAC (308A, 308B) perform the functions listed in clause 6 of the 3GPP specification. The RRC (314A, 314B) performs the functions listed in clause 7 of the 3GPP specification. The NAS (312A, 312B) performs authentication, mobility management, and security control functions.

The main services and functions of the MAC (308A, 308B) include mapping between logical channels and transport channels, multiplexing/demultiplexing of SDUs belonging to one or different logical channels into/from transport blocks (TB) delivered to/from the physical layer on transport channels, scheduling information reporting, error correction through HARQ (one HARQ entity per cell in case of CA), priority handling between the UE (202) by means of dynamic scheduling, priority handling between logical channels of one UE (202) by means of logical channel prioritization, priority handling between overlapping resources of one UE (202), padding, and the like.

Multiple cells, transmission times, and numerologies may be supported by a single MAC entity. Which numerology (IEs), cell(s), and transmission timing(s) a logical channel may employ are determined by mapping limits in logical channel priority. Typically, during a handover, top levels initiate the MAC reset. The network notifies the cell switch to the MAC (308A, 308B) directly regarding LTM. In this way, the MAC (308A, 308B) may reset without requiring input from the UE (202). However, this might lead to problems when the UE (202) finishes LTM following a failure. Hence, a particular solution regarding the RRC-MAC interactions is required.

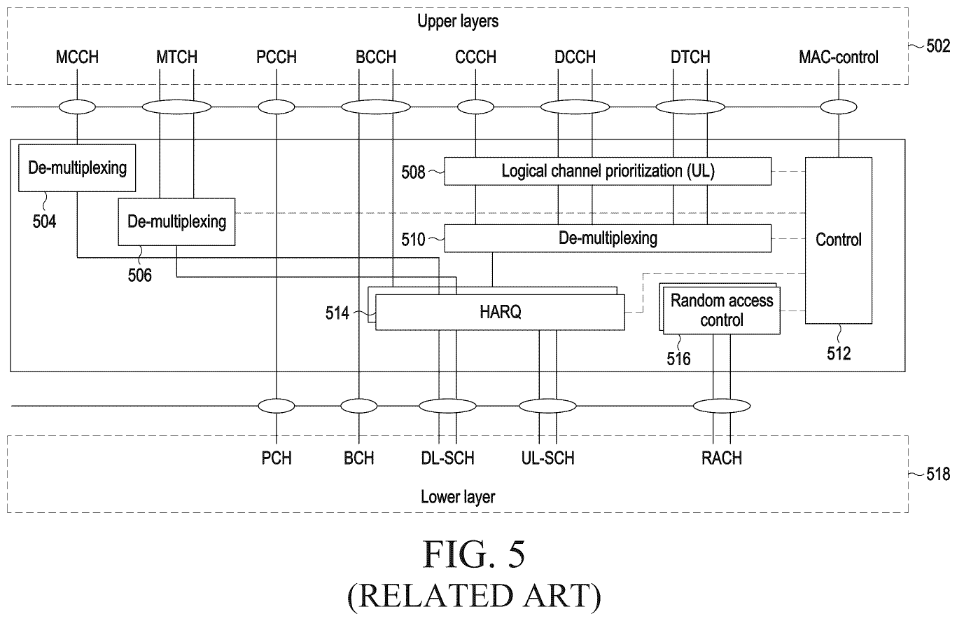

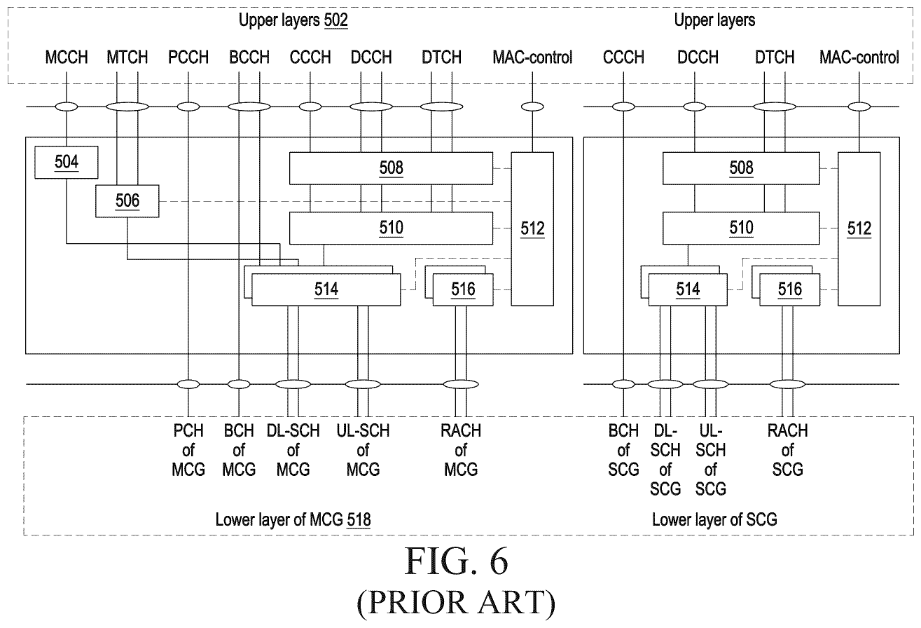

FIG. 5 illustrates a block diagram of a structure for the MAC entities when MCG and SCG are configured. FIG. 6 illustrates a block diagram of a MAC structure with two MAC entities. The structure for the MAC entities and the MAC structure with two entities include an upper layer (502), a de-multiplexing (504, 506, 510), a logical channel prioritization (508), a control (512), a HARQ (514), a random access control (516), and a lower layer (518).

The transport channels are managed by the UE's MAC entity. Two MAC entities are set to the UE when it is equipped with SCG, one for the MCG and one for the SCG. Two MAC entities are utilized by the UE when it is equipped with DAPS handover, one for the source cell (source MAC entity) and one for the target cell (target MAC entity).

Unless otherwise noted, the various MAC entities in the UE perform their respective tasks individually. Unless otherwise noted, each MAC entity's timings and settings are set up separately. Unless otherwise noted, the Serving Cells, C-RNTI, radio bearers, logical channels, upper and lower layer entities, LCGs, and HARQ entities that are taken into consideration by each MAC entity are those that are mapped to that MAC entity. One DL-SCH, one UL-SCH, and one RACH on the SpCell, one DL-SCH, zero or one UL-SCH, and zero or one RACH on each SCell are present if the MAC entity is configured with one or more SCells. There may also be multiple DL-SCH, multiple UL-SCH, and multiple RACH per MAC entity. If the MAC entity is not configured with any SCell, there is one DL-SCH, one UL-SCH, and one RACH per MAC entity.

In the existing art, the UE performs handover operations by sending layer 3 (Radio Resource Control, RRC) messages, which causes considerable signaling overhead and latency issues. The reliance on layer 3 messages for handover operations introduces inefficiencies, as these messages require additional processing time and resources. This can lead to delays in the handover process, which may result in temporary loss of connectivity or degraded service quality. The signaling overhead associated with these messages also places a burden on network resources, potentially impacting the performance of other network operations and reducing overall network efficiency.

Moreover, the existing art does not provide any mechanism on how the UE's Medium Access Control (MAC) and RRC layers interact for performing a MAC reset after receiving a Long-Term Evolution (LTE) Mobility (LTM) cell switch command. This lack of a defined interaction mechanism between the MAC and RRC layers can lead to inconsistencies and errors during the handover process. For instance, without a clear protocol for MAC reset, the UE may experience synchronization issues or data loss, further exacerbating the latency and reliability problems. The absence of a standardized procedure for MAC reset also complicates the development and implementation of handover algorithms, making it challenging for manufacturers to ensure seamless and efficient handover operations.

To address these challenges, there is a need for an improved handover mechanism that minimizes signaling overhead and latency while ensuring reliable interaction between the MAC and RRC layers. Such a mechanism could involve the development of new protocols or enhancements to existing ones that streamline the handover process. For example, incorporating a direct communication pathway between the MAC and RRC layers could facilitate quicker and more efficient MAC resets, reducing the likelihood of errors and improving overall handover performance. Additionally, optimizing the signaling process to reduce the number and complexity of layer 3 messages could help alleviate the burden on network resources, leading to a more efficient and responsive network. By addressing these issues, it would be possible to enhance the user experience, particularly in scenarios requiring frequent handovers, such as in high-mobility environments or dense urban areas.

In the proposed solution, 3GPP Release 18 considers Lower Layers (L1/L2 layers) Triggered Mobility, also known as LTM, to solve the problem related to latency, signaling overhead, etc., associated with Layer 3 mobility. As per 3GPP, the goal of LTM is to enable a serving cell change via L1/L2 signaling in order to reduce the latency, overhead, and interruption time. The Network (for example, gNB (106) may configure the UE (202) with multiple candidate cells to allow fast application of configurations for candidate cells. The Network may further send MAC CE or L1 signaling to dynamically switch the UE (202) from a source cell to one of the configured candidate cells. Further, LTM can be triggered based on L1 measurements rather than L3 measurements. 3GPP proposes to perform LTM without resetting lower layers like MAC to avoid data loss and to reduce the additional delay of data recovery wherever it is possible.

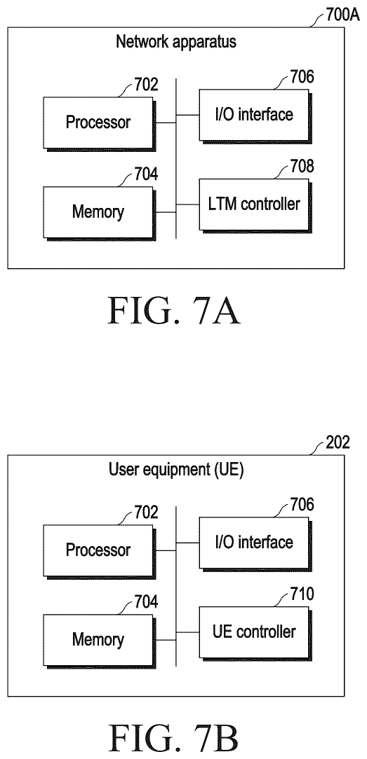

Referring now to the drawings, and more particularly to FIGS. 7 through 16B where similar reference characters denote corresponding features consistently throughout the figures, there are shown preferred embodiments.

FIG. 7A illustrates a block diagram of a schematic of a network apparatus (700A) implemented to carry out the disclosed subject matter, according to embodiments as disclosed herein. FIG. 7B illustrates a block diagram of a schematic of the UE (202) implemented to carry out the disclosed subject matter, according to embodiments as disclosed herein. The network apparatus (700A) includes a processor (702), a memory (704), an I/O interface (706), and a LTM controller (708). The UE (202) includes the processor (702), the memory (704), the I/O interface (706), and a UE controller (710). The UE (202) may include, but is not limited to a smart phone, mobile device, laptop, personal computer (PC), tablet, and the like.

The processor (702) communicates with the memory (704), the I/O interface (706), and the LTM controller (708). The processor (702) is configured to execute instructions stored in the memory (704) and to perform various processes. The processor (702) may include one or a plurality of processors. It may be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

The memory (704) may be accessed through the processor (702). The memory (704) is not restricted to volatile or non-volatile memory and may consist of one or more computer-readable storage media. Additionally, the memory (704) may contain non-volatile storage elements such as magnetic hard discs, optical discs, floppy discs, flash memories, EPROM, or EEPROM memories.

The I/O interface (706) transmits information between the memory (704) and external peripheral devices. The peripheral devices are the input-output devices associated with the network apparatus (700A). Furthermore, the LTM controller (708) communicates with the I/O interface (706) and the memory (704). The LTM controller (708) is an innovative hardware that is realized through the physical implementation of both analog and digital circuits, including logic gates, integrated circuits, microprocessors, microcontrollers, memory circuits, passive and active electronic components, as well as optical components.

Further, the processor (702) communicates with the memory (704), the I/O interface (706), and the UE controller (710). The processor (702) is configured to execute instructions stored in the memory (704) and to perform various processes. The processor (702) may include one or a plurality of processors. It may be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

The memory (704) may be accessed through the processor (702). The memory (704) is not restricted to volatile or non-volatile memory and may consist of one or more computer-readable storage media. Additionally, the memory (704) may contain non-volatile storage elements such as magnetic hard discs, optical discs, floppy discs, flash memories, EPROM, or EEPROM memories.

The I/O interface (706) transmits information between the memory (704) and external peripheral devices. The peripheral devices are the input-output devices associated with the UE (202). Furthermore, the UE controller (710) communicates with the I/O interface (706) and the memory (704). The UE controller (710) is an innovative hardware that is realized through the physical implementation of both analog and digital circuits, including logic gates, integrated circuits, microprocessors, microcontrollers, memory circuits, passive and active electronic components, as well as optical components.

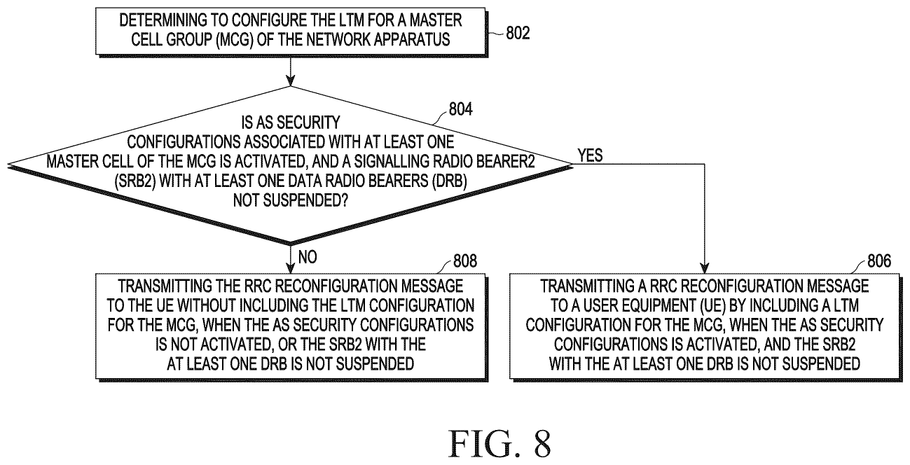

FIG. 8 illustrates a flow diagram of a method for LTM configuration in MCG according to embodiments as disclosed herein. The method comprises blocks (802-806) which may be performed using the network apparatus (700A) of FIG. 7A. Each block is explained in further detail below.

At block (802), it is determined to configure the LTM for a master cell group (MCG) of the network apparatus (700A). The MCG is a group of cells under the control of a primary gNB (also known as the master node). The MCG provides the primary connection to the UE (202), handling essential control and user plane functions.

At block (804), it is checked whether at least one of an access stratum (AS) security configurations associated with at least one master cell of the MCG is activated and a signaling radio bearer 2 (SRB2) with at least one data radio bearer (DRB) is not suspended. The AS security refers to the set of security mechanisms that protect the communication between the UE (202) and the network apparatus (700A)/network node/gNB (106). AS security is crucial for protecting the data and signaling communications between the UE (202) and the network apparatus (700A). It involves integrity protection, encryption, and sophisticated key management procedures to ensure the confidentiality and integrity of the data transmitted. Further, the SRB2 is a signaling radio bearer used to transport NAS signaling messages, playing a crucial role in managing higher-layer signaling between the UE (202) and the network apparatus (700A). The SRB2 ensures that essential NAS procedures such as mobility management and session management are carried out efficiently and securely.

At block (806), an RRC reconfiguration message is transmitted to the UE (202) by including an LTM configuration for the MCG when the AS security configurations are activated and the SRB2 with the at least one DRB is not suspended. The RRC reconfiguration message is a vital signaling tool that enables dynamic and flexible management of the NG-RAN (104). It supports various functions such as handover, resource allocation, carrier aggregation, and security updates, ensuring efficient and secure communication in the NG-RAN (104). Further, the LTM configuration may include a reference configuration, a reference signal configuration, a configuration for controlling one or more candidate cells for resetting a layer 2 of the LTM during LTM cell switch execution, random access resources, a group of channel state information (CSI) resources for configuring one or more candidate cells for LTM, and a configuration related to the transmission configuration indication (TCI) states of the one or more candidate cells. Providing the reference configuration while the AS security is established and SRB2 and at least one DRB is configured allows the network node to include the information that could be securely provided, such as information related to user's services which may have privacy concerns etc. also to be included in the reference configuration, thereby avoiding re-preparation or reconfiguration of LTM. Similarly configuring the reference signal configuration, CSI resources and TCI states only after the AS security is established and SRB2 and at least one DRB is configured prevents the UE from performing unnecessary operations and reporting thereby saving signaling and reducing the power consumption. Likewise the configuration for controlling one or more candidate cells for resetting a layer 2 of the LTM during LTM cell switch execution can be a sensitive information for the network and providing it earlier than AS security establishment or the establishment of SRB2 or DRB may have additional complexities with respect to privacy and signaling.

At block (808), the RRC reconfiguration message is transmitted to the UE (202) without including the LTM configuration for the MCG when the AS security configurations are not activated or the SRB2 with the at least one DRB is not suspended.

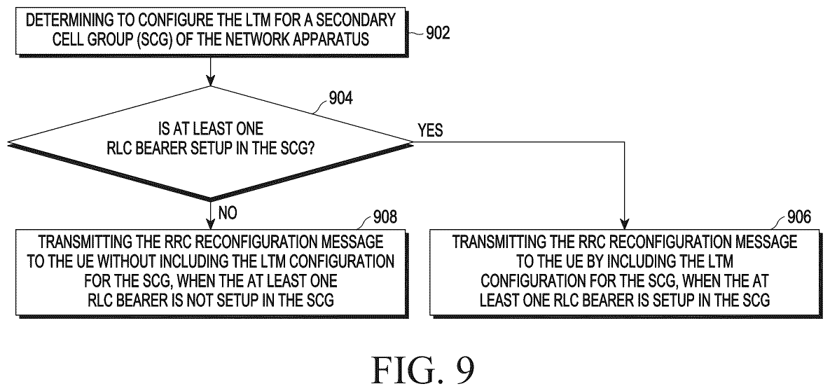

FIG. 9 illustrates a flow diagram of a method for LTM configuration in SCG according to embodiments as disclosed herein. The method comprises blocks (902-906) which may be performed using the network apparatus (700A) of FIG. 7A. Each block is explained in further detail below.

At block (902), it is determined to configure the LTM for a secondary cell group (SCG) of the network apparatus (700A). The SCG is a group of cells controlled by a Secondary gNB (SgNB), which works alongside a Master gNB (MgNB) to enhance the performance and capabilities of the network for the UE (202). This setup is part of the dual connectivity framework where the UE (202) is connected to two different gNBs simultaneously.

At block (904), it is checked whether at least one RLC bearer is set up in the SCG. The RLC bearer is a logical channel that handles the segmentation, reassembly, error correction, and in-sequence delivery of data packets. It operates between the MAC layers and the PDCP layers, providing reliable data transfer services.

At block (906), the RRC reconfiguration message is transmitted to the UE (202) by including the LTM configuration for the SCG when the at least one RLC bearer is set up in the SCG. For instance, the LTM configuration may include a reference configuration, a reference signal configuration, a configuration for controlling one or more candidate cells for resetting a layer 2 of the LTM during LTM cell switch execution, random access resources, a group of channel state information (CSI) resources for configuring one or more candidate cells for LTM, and a configuration related to transmission configuration indication (TCI) states of the one or more candidate cells. Providing the reference configuration after at least one RLC bearer is set up ensures that the reference configuration contains sufficient information for the UE to apply at the time of cell switch, without a reconfiguration. Similarly, providing the reference signal configuration or CSI resources or TCI state information or random access resources after at least one RLC bearer is set up ensures that the UE memory and processing is not utilized for unnecessary operations before the handling of the relevant measurements or the application of the related configuration is useful at the network. Likewise the configuration for controlling one or more candidate cells for resetting a layer 2 of the LTM during LTM cell switch execution is also provided after at least one RLC bearer is set up since it is complementing other information provided after at least one RLC bearer is set up.

At block (908), the RRC reconfiguration message is transmitted to the UE (202) without including the LTM configuration for the SCG when the at least one RLC bearer is not set up in the SCG.

In an embodiment, the gNB (106) includes the reference signal configurations for controlling whether a cell is subject to L2 reset during LTM cell switch execution, random access resources for the early UL synchronization procedure, a group of CSI resources for LTM candidate cell configuration, and candidate TCI states in RRC Reconfiguration for Master Cell Group (MCG) LTM only when AS security has been activated.

In an embodiment, the gNB (106) includes the reference signal configurations for controlling whether a cell is subject to L2 reset during LTM cell switch execution, random access resources for the early UL synchronization procedure, a group of CSI resources for LTM candidate cell configuration, and candidate TCI states in RRC Reconfiguration for MCG LTM only when SRB2 with at least one of one DRB is set up and not suspended or when multicast MRB or for IAB SRB2 are set up and not suspended.

In an embodiment, the gNB (106) includes the reference signal configurations for controlling whether a cell is subject to L2 reset during LTM cell switch execution, random access resources for the early UL synchronization procedure, a group of CSI resources for LTM candidate cell configuration, and candidate TCI states in RRC Reconfiguration for MCG LTM only when SRB2 with at least one of one DRB is set up and not suspended.

In an embodiment, the gNB (106) includes the reference signal configurations for controlling whether a cell is subject to L2 reset during LTM cell switch execution, random access resources for the early UL synchronization procedure, a group of CSI resources for LTM candidate cell configuration, and candidate TCI states in RRC Reconfiguration for MCG LTM only when SRB2 with at least one of one DRB is set up and not suspended or when multicast MRB is set up and not suspended.

In an embodiment, the gNB (106) includes any information for MCG LTM in LTM-Config SEQUENCE only when AS security has been activated.

In an embodiment, the gNB (106) includes any information for MCG LTM in LTM-Config SEQUENCE only when SRB2 with at least one of one DRB is set up and not suspended or when multicast MRB or for IAB SRB2 are set up and not suspended.

In an embodiment, the gNB (106) includes any information for MCG LTM in LTM-Config SEQUENCE in RRC Reconfiguration only when SRB2 with at least one of one DRB is set up and not suspended.

In an embodiment, the gNB (106) includes any information for MCG LTM in LTM-Config SEQUENCE when SRB2 with at least one of one DRB is set up and not suspended or when multicast MRB is set up and not suspended.

In an embodiment, the gNB (106) includes any LTM-related information in SpcellConfig for MCG LTM (Serving cell specific MAC and PHY parameters for a SpCell) only when AS security has been activated.

In an embodiment, the gNB (106) includes any information in SpcellConfig (Serving cell specific MAC and PHY parameters for a SpCell) for MCG LTM only when SRB2 with at least one of one DRB is set up and not suspended or when multicast MRB or for IAB SRB2 are set up and not suspended.

In an embodiment, the gNB (106) includes any information in SpcellConfig (Serving cell specific MAC and PHY parameters for a SpCell) for MCG LTM only when SRB2 with at least one of one DRB is set up and not suspended.

In an embodiment, the gNB (106) includes any information in SpcellConfig (Serving cell specific MAC and PHY parameters for a SpCell) for MCG LTM only when SRB2 with at least one of one DRB is set up and not suspended or when multicast MRB is set up and not suspended.

In an embodiment, the gNB (106) includes any information for SCG LTM in LTM-Config SEQUENCE only when at least one RLC bearer is set up in SCG. In an embodiment, the gNB (106) includes any LTM-related information in SpcellConfig for MCG LTM (Serving cell specific MAC and PHY parameters for a SpCell) only when at least one RLC bearer is set up in SCG.

In an embodiment, the gNB (106) includes LTM reference configuration, LTM measurement configuration, the reference signal configuration, configurations for controlling whether a cell is subject to L2 reset during LTM cell switch execution, random access resources for the early UL synchronization procedure, group of CSI resources for LTM candidate cell configuration and candidate TCI states in RRC Reconfiguration for SCG LTM only when at least one RLC bearer is setup in SCG.

The above embodiments may be represented as below in the TS 38.331.

The network apparatus (700A) may initiate the RRC reconfiguration procedure to the UE (202) in RRC_CONNECTED. The network apparatus (700A) applies the procedure as follows:
the LTM-Config for LTM on the MCG is included only when AS security has been activated, and SRB2 with at least one DRB are setup and not suspended;
the LTM-Config for LTM on the SCG is included only when at least one RLC bearer is setup in SCG.

Alternately, the network apparatus (700A) may initiate the RRC reconfiguration procedure to the UE (202) in RRC_CONNECTED. The network apparatus (700A) applies the procedure as follows:
the LTM-Config or any LTM related information in SpCellConfig for LTM on the MCG is included only when AS security has been activated, and SRB2 with at least one DRB are setup and not suspended;
the LTM-Config or any LTM related information in SpCellConfig for LTM on the SCG is included only when at least one RLC bearer is setup in SCG.

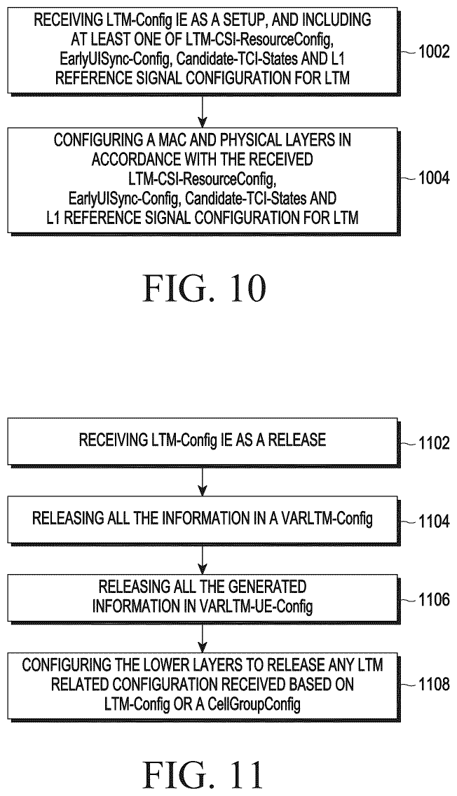

FIG. 10 illustrates a flow diagram of a method for handling of LTM configuration set as a setup, according to embodiments as disclosed herein. The method includes blocks (1002-1004). Each block is explained in further detail below.

At block (1002), a LTM-config information element (IE) is received as a setup. The LTM-config IE may be used in the RRC layer to configure a last transmission mechanism. It provides parameters and settings that dictate how the UE (202) and the gNB (106) should handle the last transmissions before a connection release or state transition. For instance, the LTM-config IE may include at least one of LTM-CSI-ResourceConfig, EarlyUISync-Config, Candidate-TCI-States and L1 reference signal configuration for LTM, and the like.

At block (1004), the MAC and physical layers may be configured in accordance with the received LTM-CSI-ResourceConfig, EarlyUISync-Config, Candidate-TCI-States and L1 reference signal configuration for LTM.

In an embodiment, upon reception of RRC Reconfiguration or upon execution of the conditional reconfiguration (CHO, CPA or CPC) including ltm-Config IE, the UE (202) checks if the IE is set as setup and if the ltm-Config IE is set as setup, the UE (202) performs the LTM configuration in RRC layer as per 5.3.5.x. Traditionally, to facilitate the late protocol check (i.e., ASN.1 validation for the LTM candidate cell configuration which is done in RRC layer), the LTM configuration is provided to lower layers at the time of cell switch, rather than at the time of reception of LTM configuration.

In an embodiment, if the ltm-Config IE is set as setup and if it includes the L1 reference signal configuration (RS configuration for SSB-based measurements of candidate cells or RS configuration for CSI-based measurements of candidate cells), the UE RRC configures the lower layers with the received reference signal configuration.

In an embodiment, if the ltm-Config IE is set as setup and if it includes the configurations of TCI states for the candidate cells, the UE RRC configures the lower layers with the received configurations of TCI states for the candidate cells.

In an embodiment, if the ltm-Config IE is set as setup and if it includes the configurations of TCI states for the candidate cells, the UE RRC configures the lower layers with the received configurations of TCI states for the candidate cells.

In an embodiment, if the ltm-Config IE is set as setup and if it includes the configurations of CSI resource configuration, the UE RRC configures the lower layers with the received configurations of CSI resource configuration.

In an embodiment, if the ltm-Config IE is set as setup and if it includes the configurations of random access resources for the early UL synchronization procedure (EarlyUlSync-Config), the UE RRC configures the lower layers with the received configurations of random access resources for the early UL synchronization procedure (EarlyUlSync-Config).

The above changes may be represented by the below example specification extract in TS 38.331.

```
1> if the RRCReconfiguration message includes the ltm-Config set as setup:
  2> perform the LTM configuration procedure as specified in 5.3.5.x;
  2> configure lower layers in accordance with the received LTM-CSI-ResourceConfig,
EarlyUlSync-Config, Candidate-Tci-States and L1 reference signal configuration for LTM.
```

In an alternate embodiment, gNB (MN) may include LTM reference configuration before AS security activation, but doesn't include any of the DRB or SRB2 configurations in the reference configuration. Such an implementation may be chosen in case the reference configuration itself can be provided as a delta configuration since this allows reduced one time signaling, but can lead to a suboptimal implementation otherwise.

In an alternate embodiment, gNB (SN) may include LTM reference configuration when at least one RLC bearer is setup in SCG is not setup, but doesn't include any of the DRB or SRB2 configurations in the reference configuration. Such an implementation may be chosen in case the reference configuration itself can be provided as a delta configuration since this allows reduced one time signaling, but can lead to a suboptimal implementation otherwise.

FIG. 11 illustrates a flow diagram of a method for handling of LTM configuration set as a release, according to embodiments as disclosed herein. The method includes blocks (1102-1108). Each block is explained in further detail below.

At block (1102), the LTM-Config IE set is received. In the RRC layer, a last transmission mechanism may be configured using the LTM-config IE. It offers options and parameters that specify how the gNB (106) and the UE (202) should manage the last transmissions before to a state change or connection release.

At block (1104), the LTM-Config IE received in block (1102) is released in a VARLTM-config. The VARLTM-config may refer to the configuration settings for the Variable Last Transmission Mechanism (VARLTM) in 5G networks. This configuration may be part of the RRC protocol and specifies how the UE (202) and the gNB (106) should handle the last transmissions in a variable manner before a connection release or state transition. The VARLTM-config provides flexibility in handling the final data transmissions before a connection release or state transition.

At block (1106), the information generated or present in the VARLTM-config released in block (1104) is released. Further, at block (1108), the lower layers are configured to release any LTM related configuration received based on LTM-Config or a CellGroupConfig. The LTM-Config (Last Transmission Mechanism configuration) is an IE within the RRC that specifies how the UE (202) and the network apparatus (700A) should handle the final transmissions before a connection release or a state transition (e.g., moving from RRC_CONNECTED to RRC_IDLE). The goal of the LTM-config is to ensure that all important data is transmitted reliably and efficiently, even as the UE (202) transitions between different states or releases its connection. The CellGroupConfig is a configuration element that defines the parameters and settings associated with a Cell Group. A Cell Group represents a group of cells within a network that share certain characteristics or configurations. The CellGroupConfig may be utilized to configure and manage these Cell Groups, ensuring optimal network performance and resource utilization.

In an embodiment, upon reception of RRC Reconfiguration or upon execution of the conditional reconfiguration (CHO, CPA or CPC) including ltm-Config IE, the UE (202) checks if the IE is set as setup and if the ltm-Config IE is set as release, UE RRC removes (releases) all the information stored in VarLTM-Config. In an embodiment, if the ltm-Config IE is set as release, UE RRC removes (releases) all the information stored in VarLTM-UE-Config. UE RRC removes the generated LTM configuration.

In an embodiment, if the ltm-Config IE is set as release, the UE RRC configure lower layers to release the L1 reference signal configuration (RS configuration for SSB-based measurements of candidate cells or RS configuration for CSI-based measurements of candidate cells), the received configurations of TCI states for the candidate cells, the received configurations of CSI resource configuration and the received configurations of random access resources for the early UL synchronization procedure (EarlyUlSync-Config).

In an embodiment, if the ltm-Config IE is set as release, UE RRC configures lower layers to release the CSI report configuration within the serving cell's Spcell configuration.

In an embodiment, if the ltm-Config IE is set as release, the UE RRC releases all the LTM candidate cell configurations.

In an embodiment, this may be represented in TS 38.331 as below.

1> if the RRCReconfiguration message includes the ltm-Config set us release:
2> perform the LTM configuration release procedure as specified in 5.3.5.x.y;
5.3.5.x.y LTM config release

The UE (202) shall:

1>remove all the information stored in VarLTM-Config amd VarLTM-UE-Config
1>configure lower layers to release any LTM related configuration received from LTM-Config
and CellGroupConfig

Alternatively, 5.3.5.x.y may be specified as below.

5.3.5.x.y LTM config release

### 5.3.5.x.y LTM Config Release

The UE (202) shall:

2>remove all the information stored in VarLTM-Config amd VarLTM-UE-Config
1>configure lower layers to release LTM-CSI-ResourceConfig, EarlyUlSync-Config,
Candidate-Tci-States and L1 reference signal configuration for LTM.

The lower layers configured in the aspect 2 are MAC layer or physical layer. The above embodiments in aspect 2 are applicable even when the LTM configuration is provided using any IE other than ltm-Config IE and in any wireless technology. In an alternate implementation way, Ltm-config may be provided as an IE which is not setuprelease and the behavior for setup may remain the same.

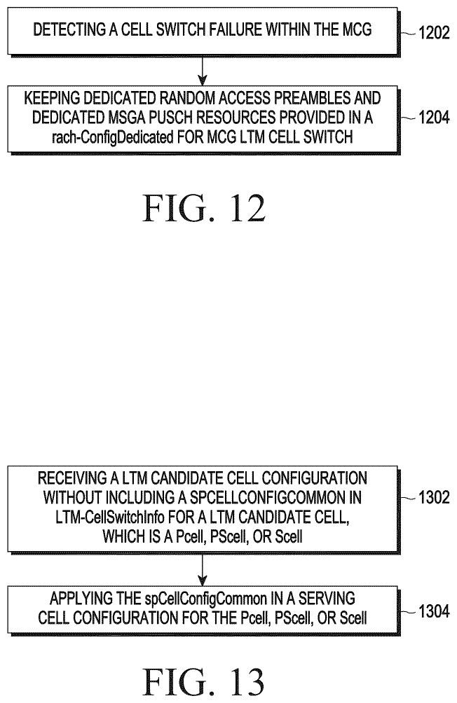

FIG. 12 illustrates a flow diagram of a method for cell switch failure handling, according to embodiments as disclosed herein. The method includes blocks (1202-1204). Each block is explained in further detail below.

At block (1202), a cell switch failure is detected within the MCG. The cell switch failure refers to a failure or malfunction in the switch or control mechanisms responsible for managing a cell within the NG-RAN (104). Cell switch failures may lead to service disruptions, degraded performance, and the like.

At block (1204), dedicated random access preambles and dedicated msgA PUSCH resources provided in a rach-ConfigDedicated for MCG LTM Cell Switch are kept/retained. The rach-ConfigDedicated refers to the configuration parameters related to the Random Access Channel (RACH) that are dedicated to the UE (202). The Random Access Channel may be used by the UE (202) to initiate communication with the gNB (106) when establishing an initial connection or when requesting resources for data transmission.

Traditionally upon L3 handover failure, the UE (202) releases the dedicated random access preambles provided for the mobility. In an embodiment, upon LTM cell switch failure (T3xx failure as mentioned in background) of MCG, the UE (202) keeps the dedicated preambles provided in rach-ConfigDedicated and the dedicated msgA PUSCH resources provided in rach-ConfigDedicated for MCG.

In an embodiment, upon LTM cell switch failure (T3xx failure as mentioned in background) of SCG, the UE (202) keeps the dedicated preambles provided in rach-ConfigDedicated and the dedicated msgA PUSCH resources provided in rach-ConfigDedicated for SCG.

In an embodiment, this may be specified in NR TS 38.331 as below.

5.3.5.8.X T3xx expiry (LTM cell switch failure)

The UE (202) shall:

```
1> if T3xx of MCG expires:
  2> release dedicated preambles provided in rach-ConfigDedicated if configured;
  2> initiate the connection re-establishment procedure as specified in clause 5.3.7.
1> else if T3xx of SCG expires:
  2> if MCG transmission is not suspended:
    3> initiate the SCG failure information procedure as specified in clause 5.7.3
  to report SCG LTM cell switch failure, upon which the RRC reconfiguration procedure ends;
  2> else:
    3> initiate the connection re-establishment procedure as specified in clause
5.3.7;
```

FIG. 13 illustrates a flow diagram of a method for SpCellConfigCommon configuration for a LTM candidate cell which is a serving cell-2, according to embodiments as disclosed herein. The method includes blocks (1302-1304). Each block is explained in further detail below.

At block (1302), a LTM candidate cell configuration is received without including a spCellConfigCommon in LTM-CellSwitchInfo for a LTM candidate cell, which is a Pcell, PScell, or SCell. The spCellConfigCommon may refer to configuration parameters that are common to the Serving Primary Cell (sPCell) within a cell group. These parameters define the characteristics and behavior of the sPCell, ensuring optimal operation, performance, and quality of service for user equipment within the cell group.

At block (1304), the spCellConfigCommon is applied in a serving cell configuration for the Pcell, PScell, or SCell. The serving cell configuration may refer to a set of parameters and settings that define the operational characteristics of the serving cell of the UE (202). The serving cell is the primary cell with which the UE (202) is connected and communicates most of the time. The serving cell configuration encompasses various aspects of the cell's operation, including physical layer parameters, radio resource allocation, mobility management, quality of service (QoS) policies, and the like.

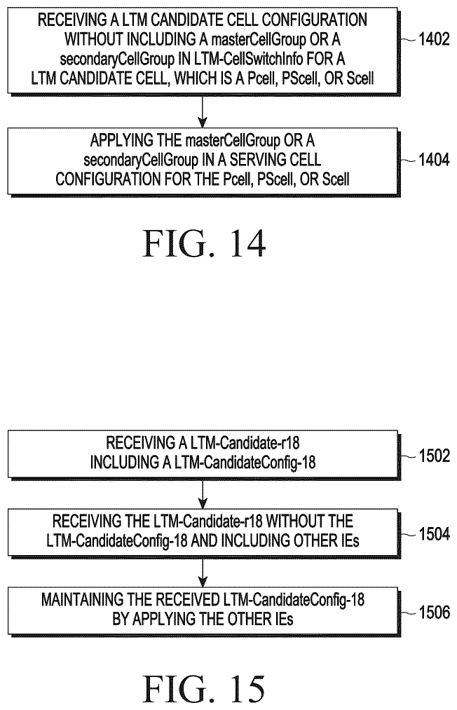

FIG. 14 illustrates a flow diagram of a method for CellGroupConfig configuration for a LTM candidate cell which is a serving cell, according to embodiments as disclosed herein. The method includes blocks (1402-1404). Each block is explained in further detail below.

At block (1402), the LTM candidate cell configuration is received without including a masterCellGroup or a secondaryCellGroup in LTM-CellSwitchInfo for a LTM candidate cell, which is a Pcell, PScell, or SCell. Further, at block (1404), the masterCellGroup or a secondaryCellGroup is applied in a serving cell configuration for the Pcell, PScell, or SCell.

In an embodiment, the gNB (106) excludes providing the ServingCellConfigCommon in LTM candidate cell configuration if the LTM candidate cell is a serving cell. For e.g. LTM-CellSwitchInfo-r18 as mentioned in the background may not include spCellConfigCommon-r18 when the LTM candidate cell is a serving cell. This may be valid for both primary serving cell and secondary serving cell.

In an embodiment, the gNB (106) excludes providing the masterCellGroup or secondaryCellGroup in LTM candidate cell configuration if the LTM candidate cell is a serving cell (PCell/PSCell/SCell).

In an embodiment, if the UE (202) receives LTM candidate cell configuration without including ServingCellConfigCommon (such as the case when the UE (202) has received LTM-CellSwitchInfo-r18 without spCellConfigCommon-r18) and when the LTM candidate cell is also a serving cell (primary serving cell or secondary serving cell), the UE (202) applies the ServingCellConfigCommon previously received in the serving cell configuration for the primary cell or secondary cell. (i.e., the UE (202) applies the received ServingCellConfigCommon configuration for the PCell/PSCell/SCell as the ServingCellConfigCommon for the LTM candidate cell when they are same cells such as CGI or PCI and frequency of the cells are same).

In an embodiment, if the UE (202) receives LTM candidate cell configuration without including masterCellGroup or secondaryCellGroup (such as the case when the UE (202) has received LTM candidate cell configuration without masterCellGroup or secondaryCellGroup) for a serving cell (primary serving cell or secondary serving cell), applies the masterCellGroup or secondaryCellGroup previously received in the serving cell configuration for the primary cell or secondary cell (i.e., the UE (202) applies the received masterCellGroup or secondaryCellGroup configuration for the PCell/PSCell/SCell as the masterCellGroup or secondaryCellGroup for the LTM candidate cell when they are same cells such as CGI or PCI and frequency of the cells are same).

In an embodiment, this may be represented as below in TS 38.331.

| | |
|---|---|
| LTM-CellSwitchInfo-r18 ::= | SEQUENCE { |
| spCellConfigCommon-r18 | ServingCellConfigCommon |

OPTIONAL, -- Cond LTM-ToNonServingcell

| | |
|---|---|
| newUE-Identity-r18 | RNTI-Value, |
| rach-ConfigDedicated-r18 | CHOICE { |
| uplink-r18 | RACH-ConfigDedicated, |
| supplementary Uplink-r18 | RACH-ConfigDedicated |
| } | OPTIONAL, -- Need N} |

| Conditional Presence | Explanation |
|---|---|
| LTM-ToServingCell | The field is mandatorily present in case the LTM |
| | candidate cell is already a configured serving |
| | cell; otherwise it is optionally present, need M. |

```
5.3.5.5 Cell Group configuration
5.3.5.5.1 General
1> if this procedure is initiated due to an LTM cell switch procedure:
  2> if CellGroupConfig contains the ltm-CellSwitchInfo:
    3> apply as the C-RNTI for this cell group the value included in newUE-
Identity within the field ltm-CellSwitchInfo of the LTM candidate cell configuration indicated
by lower layers;
    3> if ltm-CellSwitchInfo includes spCellConfigCommon-r18
      4> configure lower layers in accordance with the received
spCellConfigCommon within the field ltm-CellSwitchInfo of the LTM candidate cell
configuration indicated by lower layers;
    3> else if the LTM candidate cell is a serving cell
      4> configure lower layers in accordance with the
spCellConfigCommon received for the serving cell configuration of the PCell/SCell before
LTM execution.
    3> configure lower layers in accordance with the received rach-
ConfigDedicated within the field ltm-CellSwitchInfo of the LTM candidate cell configuration
indicated by lower layers.
```

For example, let us consider the case of a cell Cell1 which is the PCell for the UE (202). The UE (202) received spCellConfigCommon in RRCSetup or RRCResume or RRCReconfiguration message. In a later step, let us consider that the gNB (106) has configured the UE (202) with LTM candidate cells and the Cell1 is also a LTM candidate cell. According to our embodiments, the gNB (106) may not provide Cell1 with spCellConfigCommon. Upon executing the cell switch procedure, UE RRC configures the lower layers using the spCellConfigCommon received in previous step in place of the SpCellConfigCommon for the LTM candidate cell.

Now let us consider the case of a cell Cell2 which is the PSCell for the UE (202). The UE (202) received spCellConfigCommon in RRCReconfiguration message during SCG addition. In a later step, let us consider that the gNB (106) has configured the UE (202) with LTM candidate cells and the Cell2 is also a LTM candidate cell. According to our embodiments, gNB (106) may not provide Cell2 with spCellConfigCommon. Upon executing the cell switch procedure to Cell2, UE RRC configures the lower layers using the spCellConfigCommon received in previous step in place of the SpCellConfigCommon for the LTM candidate cell.

Now let us consider the case of a cell Cell3 which is the secondary cell for the UE (202). The UE (202) received sCellConfigCommon in RRCReconfiguration message during SCell addition. In a later step, let us consider that the gNB (106) has configured the UE (202) with LTM candidate cells and the Cell3 is also a LTM candidate cell. According to our embodiments, the gNB (106) may not provide Cell3 with spCellConfigCommon. Upon executing the cell switch procedure to Cell2, UE RRC configures the lower layers using the sCellConfigCommon received in previous step in place of the SpCellConfigCommon for the LTM candidate cell.

FIG. 15 illustrates a flow diagram of a method for ltm-CandidateConfig-r18 configuration, according to embodiments as disclosed herein. The method includes blocks (1502-1506). Each block is explained in further detail below.

At block (1502), a LTM-Candidate-r18 including a LTM-CandidateConfig-18 is received. At block (1504), the LTM-Candidate-r18 is received without the LTM-CandidateConfig-18 and including other IEs. Further, at block (1506), the received LTM-CandidateConfig-18 is maintained by applying the other IEs.

In an embodiment, the gNB (106) sends the UE (202) the ltm-CandidateConfig-r18 containing RRC Reconfiguration within LTM-Candidate-r8 optionally. The gNB (106) may send the UE (202) LTM-Candidate-r18 including only any of earlyULSyncConfig, LTM candidate TCI state configuration addition/release, LTM CSI Resource configuration addition/release LTM candidate configuration without including corresponding ltm-CandidateConfig-r18 containing RRC Reconfiguration. If the UE (202) receives the LTM-Candidate-r18 without the ltm-CandidateConfig-r18 containing RRC Reconfiguration, the UE (202) maintains the previously received value for ltm-CandidateConfig-r18.

This may be represented by the below specification extract.

```
LTM-Candidate-r18 ::= SEQUENCE {
  ltm-CandidateId-r18 LTM-CandidateId-r18,
  ltm-CandidateConfig-r18 OCTET STRING (CONTAINING RRCReconfiguration
) OPTIONAL -Need M,
  ltm-ConfigComplete-r18 ENUMERATED {true} OPTIONAL,
-- Need R
  ltm-EarlyUlSyncConfig-r18 SetupRelease { EarlyUlSyncConfig-r18 }
OPTIONAL, -- Need M
  ltm-NoResetID-r18 INTEGER (1.. maxNrofCellsLTM-r18)
OPTIONAL, -- Need M
  ltm-Candidate-Tci-States-ToAddModList-r18  Candidate-Tci-States-r18
OPTIONAL, -- Need N
  ltm-Candidate-Tci-States-ToReleaseList-r18 Candidate-Tci-StatesId-r18
OPTIONAL, -- Need N
  ...
}
-- ASN1START
-- TAG-LTM-CONFIG-START
LTM-Config-r18 ::= SEQUENCE {
  ltm-ReferenceConfiguration-r18 SetupRelease {ReferenceConfiguration-r18}
OPTIONAL, -- Need M
  ltm-CandidateToReleaseList-r18 SEQUENCE (SIZE (1..maxNrofLTM-Configs-r18))
OF LTM-CandidateId-r18 OPTIONAL, -- Need N
  ltm-CandidateToAddModList-r18 SEQUENCE (SInIZE (1..maxNrofLTM-Configs-
r18)) OF LTM-Candidate-r18 OPTIONAL, -- Need N
  ltm-ServingCellNoResetID-r18 INTEGER (1..maxNrofLTM-Configs-r18-plus-1)
OPTIONAL, -- Cond FirstLTM-Only
  ltm-CSI-ResourceConfigToAddModList-r18 SEQUENCE (SIZE (1..maxNrofLTM-CSI-
ResourceConfigurations-r18)) OF LTM-CSI-ResourceConfig-r18
    OPTIONAL, -- Need N
  ltm-CSI-ResourceConfigToReleaseList-r18 SEQUENCE (SIZE (1..maxNrofLTM-CSI-
ResourceConfigurations-r18)) OF LTM-CSI-ResourceConfigId-r18
    OPTIONAL, -- Need N
  attemptLTM-Switch-r18 ENUMERATED {true}
OPTIONAL, -- Cond LTM-MCG
  ltm-ServingCellUE-MeasuredTA-ID-r18 INTEGER (1..maxNrofLTM-Configs-r18-plus-1)
OPTIONAL, -- Cond LTM
  ...
}
-- TAG-LTM-CONFIG-STOP
-- ASN1STOP
```

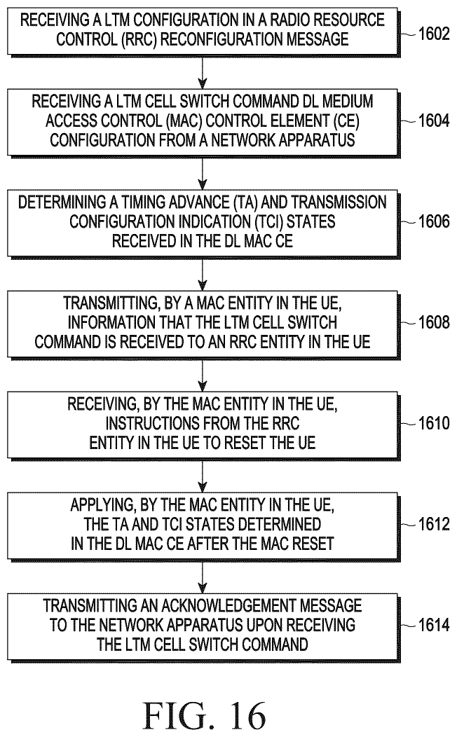

FIG. 16 illustrates a flow diagram of a method for handling LTM of an NG-RAN, according to embodiments as disclosed herein. The method comprises blocks (1602-1614), which can be executed using the UE controller (710) of FIG. 7B. Each block is explained in detail below.

At block (1602), the UE (202) receives a LTM configuration in a radio resource control (RRC) reconfiguration message. The LTM configuration may be a feature related to the measurement and reporting of network performance over an extended period. It involves configuring the network to collect and analyze data to ensure optimal performance, reliability, and efficiency of the NG-RAN.

At block (1604), the UE (202) receives a LTM cell switch command DL medium access control (MAC) control element (CE) configuration from a network apparatus (700A). The DL MAC CE provides instructions to switch from a source cell to a LTM candidate cell for the MCG or the SCG. The MAC is responsible for managing access to the wireless medium and controlling the transmission of data frames. The CE may be a specific type of message or information element used within the MAC to convey control information between the base station (eNodeB or gNB (106))/network apparatus (700A) and the UE (202).

At block (1606), the UE (202) determines a timing advance (TA) and transmission configuration indication (TCI) states received in the DL MAC CE. The TA is a mechanism used to adjust the timing of uplink transmissions from the UE (202) to ensure that the signals from different UEs arrive at the gNB (106) at the correct time. This adjustment compensates for the propagation delay between the UE (202) and the gNB (106) due to the varying distances between them. Further, the TCI may be a mechanism used to provide information about the transmission configuration used by the gNB (106) to the UE (202). It indicates parameters such as the modulation and coding scheme (MCS), resource allocation, and other transmission parameters.

At block (1608), a MAC entity in the UE (202) transmits information that the LTM cell switch command is received to an RRC entity of the UE (202). The MAC entity of the UE (202) manages the access to the radio medium, ensuring efficient and reliable communication between the UE (202) and the gNB (106). It handles various tasks such as scheduling, error correction, multiplexing, QoS management, and the like. The RRC entity of the UE (202) manages the signaling and control procedures necessary for establishing and maintaining a reliable and efficient connection with the NG-RAN. It handles tasks such as connection management, mobility, security configuration, measurement reporting, state management, and the like.

At block (1610), the MAC entity in the UE (202) receives instructions from the RRC entity in the UE (202) to reset the UE (202).

At block (1612), the MAC entity in the UE (202) applies the TA and TCI states determined in the DL MAC CE after the MAC reset.

At block (1614), the UE (202) transmits an acknowledgement message to the network apparatus (700A) upon receiving the LTM cell switch command. The acknowledgement message may be transmitted after the TA and TCI states are determined in the DL MAC CE after the MAC reset is performed. The acknowledgement message may be a RRC Reconfiguration Complete message.

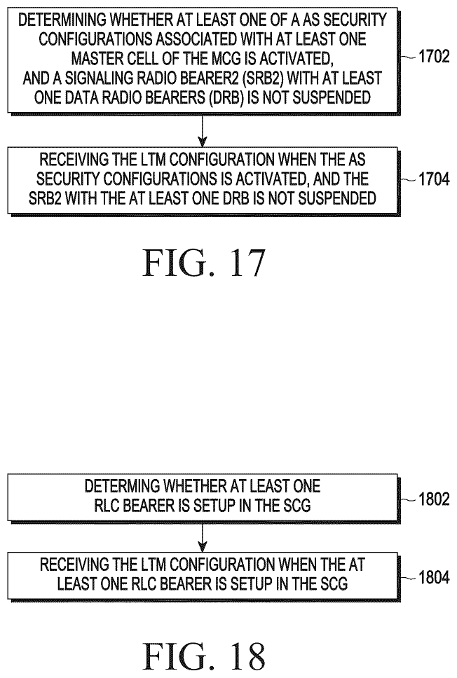

FIG. 17 illustrates a flow diagram of a method for determining AS security configurations, SRB2, and DRB in the LTM configuration received, according to embodiments as disclosed herein. The method comprises blocks (1702-1704), which can be executed using the UE controller (710) of FIG. 7B. Each block is explained in detail below.

At block (1702), the UE (202) determines whether at least one of AS security configurations associated with at least one master cell of the MCG is activated, and the SRB2 with at least one DRB is not suspended.

At block (1704), the UE (202) receives the LTM configuration when the AS security configurations is activated, and the SRB2 with the at least one DRB is not suspended. For instance, the LTM configuration may include a reference configuration, a reference signal configuration, a configuration for controlling one or more candidate cells for resetting a layer 2 of the LTM during LTM cell switch execution, random access resources, a group of channel state information (CSI) resources for configuring one or more candidate cells for LTM, and a configuration related to transmission configuration indication (TCI) states of the one or more candidate cells.

FIG. 18 illustrates a flow diagram of a method for determining RLC bearers in the LTM configuration received, according to embodiments as disclosed herein. The method comprises blocks (1802-1804), which can be executed using the UE controller (710) of FIG. 7B. Each block is explained in detail below.

At block (1802), the UE (202) determines whether at least one RLC bearer is setup in the SCG.

At block (1804), the UE (202) receives the LTM configuration when the at least one RLC bearer is setup in the SCG. For instance, the LTM configuration may include a reference signal configuration, a configuration for controlling one or more candidate cells for resetting a layer 2 of the LTM during LTM cell switch execution, random access resources, a group of channel state information (CSI) resources for configuring one or more candidate cells for LTM, and a configuration related to transmission configuration indication (TCI) states of the one or more candidate cells.

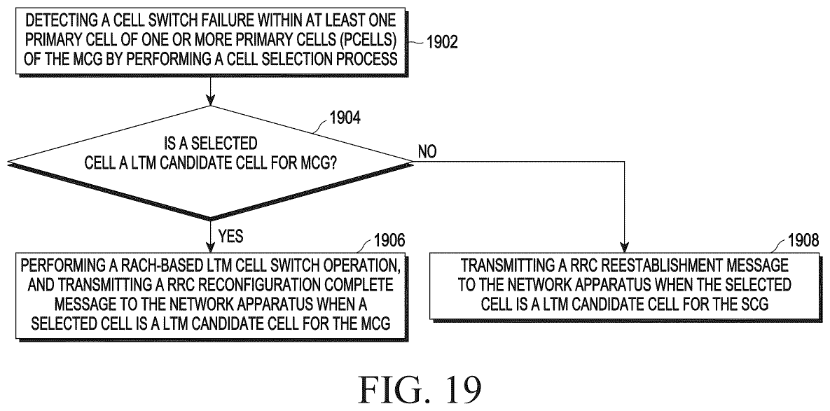

FIG. 19 illustrates a flow diagram of a method for detecting a cell switch failure, according to embodiments as disclosed herein. The method comprises blocks (1902-1908), which can be executed using the UE controller (710) of FIG. 7B. Each block is explained in detail below.

At block (1902), the UE (202) performs a cell selection process when a cell switch failure is detected within at least one primary cell of one or more primary cells (PCells) of the MCG. The cell selection process refers to the procedure by which the UE (202) selects and connects to a suitable cell for communication. This process is fundamental for establishing initial access to the network, as well as for performing handovers between cells as the UE (202) moves within the coverage area.

At block (1904), the UE (202) determines whether the selected cell is a LTM candidate cell for the MCG.

At block (1906), the UE (202) performs a RACH-based LTM cell switch operation. The RACH-based LTM cell switch operation involves utilizing the Random Access Channel (RACH) mechanism for initiating cell switching procedures during maintenance activities in a cellular network. This process allows for seamless transition between cells while minimizing disruption to ongoing communications. A RRC reconfiguration complete message is transmitted to the network apparatus (700A) when a selected cell is a LTM candidate cell for the MCG. The RRC reconfiguration complete message indicates the successful completion of a radio resource control reconfiguration procedure between the UE (202) and the gNB (106).

At block (1906), a RRC reestablishment message to the network apparatus (700A) when the selected cell is a LTM candidate cell for the SCG. The RRC reestablishment message is a signaling message to initiate the reestablishment of an RRC connection between the UE (202) and the gNB (106). This procedure occurs when the existing RRC connection has been lost or needs to be reestablished due to factors such as handover failure, radio link failure, or network reconfiguration.

In an embodiment, the UE (202) may receive RRC configuration for updating some of the security parameters. For the purpose of the present invention, 3gpp specifications such as TS38.300, TS38.331, TS 38.321 V17.2.0 is considered as relevant background.

In an embodiment, the UE (202) may trigger MAC Reset procedure as in TS38.321 section 5.12 upon receiving LTM cell switch command.

The gNB (106) may provide LTMCandidateConfiguration, i.e. configure LTM candidate cells through one RRCReconfiguration message for a candidate target cell. The gNB (106) may further release or modify the candidate configurations. The UE (202) may store the LTM configuration of other candidate cells even after moving to a candidate cell through LTM. The gNB (106) also may provide the UE (202) with configuration for performing LTM measurements for different candidate frequencies and candidate cells and reporting based on the performed LTM measurements.

The UE (202) performs the L1 measurements on the source cell and candidate cell and report L1 measurements through CSI reports to the gNB (106) of the source cell. The gNB (106) may send a MAC CE (for e.g. LTM Cell Switch MAC CE) asking the UE (202) to switch to another cell which is a LTM candidate cell. The UE (202) may perform random access during LTM cell switch, or the cell switch may be RACH less.

Upon receiving cell switch command, UE MAC may perform the following steps:

### 18.xy LTM Cell Switch Command

The network may indicate the UE (202) to perform cell switch in the LTM procedure by sending the LTM Cell Switch Command MAC CE described in clause 6.1.3.xy.

The MAC entity shall:

```
1> if the MAC entity receives an LTM Cell Switch Command MAC CE on a Serving Cell:
  2> indicate to upper layers that the LTM Cell Switch Command MAC CE is received
    (triggering the LTM cell switch procedure);
  2> indicate to upper layers the Target Configuration ID included in the MAC CE;
  2> if Timing Advance Command value (hexa-decimal) is not set as FFF:
    3> process the received Timing Advance Command (see clause 5.2);
    3> [indicate to upper layers to skip the Random Access procedure for this LTM cell
      switch.]
    3> consider the RACH-less LTM cell switch is ongoing.
  2> else (Timing Advance Command with the value as FFF):
    3> [indicate to upper layers to trigger the Random Access procedure for this LTM cell
      switch.]
  2> if TCI state information is included:
    3> consider the SSB corresponding to the indicated TCI state as the selected SSB for
      the initial uplink transmission towards the candidate cell (see clause 5.8.2);
3> indicate to lower layers the information regarding the TCI state information included in
  the LTM Cell Switch Command MAC CE.
```

In an embodiment, the UE (202) may trigger MAC Reset procedure as in TS38.321 section 5.12 upon receiving LTM cell switch command.

In an embodiment, UE MAC perform MAC reset for LTM cell switch upon being triggered by UE RRC. Upon receiving LTM Cell Switch command DL MAC CE, UE MAC informs UE RRC that it has received LTM cell switch command DL MAC CE and the UE RRC triggers MAC reset. In an embodiment, while informing that MAC reset needs to be performed due to LTM Cell switch (i.e. while resetting the MAC), UE RRC informs UE MAC that the MAC reset is for LTM cell switch.

In an embodiment, UE MAC informs UE RRC that it has received timing advance related information in LTM Cell Switch command DL MAC CE and that timing advance could be maintained during the MAC reset. Further UE RRC informs that while MAC reset, timing advance related information could be maintained and not to be reset and UE MAC doesn't consider all timeAlignmentTimers, inactivePosSRS-TimeAlignmentTimer, and cg-SDT-TimeAlignmentTimer, if configured, as expired and doesn't perform the corresponding actions in clause 5.2 of 3gpp TS 38.321 such as in section 5.2 of TS 38.321.

In an embodiment, UE MAC may share the timing advance and TCI related information received in LTM CellSwitch Command DL MAC CE to the UE RRC. UE RRC may provide this information when it instructs UE MAC to perform MAC reset for a cellgroup for LTM cell switch. Alternatively, UE MAC for each cell group may store the received Timing Advance value and TCI information from LTM Cell Switch command DL MAC CE. After receiving instruction to perform MAC reset from RRC for LTM cell switch (or on its own after receiving DL LTM Cell Switch Command MAC CE), UE MAC may reset the MAC and apply the stored timing advance value and TCI information from LTM Cell Switch command DL MAC CE. In an embodiment, this may be performed after performing MAC reset.

In an embodiment, upon an LTM cell switch failure (T304 expiry or other failures) or radio link failure or any other failures, the UE (202) performs cell selection. The cell selection will be performed while a timer configured by the network such as T311 in the NR is running. If the selected cell is a MCG LTM candidate cell, the UE (202) may perform RACH-based LTM cell switch on the selected cell, and sends RRC Reconfiguration Complete, if the network has configured it to do so. This may be referred to as LTM cell switch for recovery in this invention.

In an embodiment, UE RRC instructs UE MAC to perform MAC reset for LTM cell switch for recovery. UE RRC informs UE MAC that the MAC reset is for LTM (i.e. for LTM cell switch). UE RRC may also inform UE MAC that the MAC reset is for LTM c cell switch for recovery, and RACHless LTM is not applicable (i.e. UE MAC need to perform random access). UE MAC doesn't apply any stored timing advance (or TCI state information) from the LTM Cell Switch command DL MAC CE when the LTM cell switch is triggered after a failure for the recovery.

In an embodiment, upon an LTM cell switch failure (T304 expiry or other failures) or radio link failure, The UE (202) performs cell selection. If the selected cell is a SCG LTM candidate cell, the UE (202) avoids performing RACH-based LTM cell switch on the selected cell, and sends RRC Reestablishment.

In an embodiment during LTM cell switch for recovery, UE RRC may inform UE MAC to perform LTM cell switch (cell switch completion through random access procedure).

During LTM cell switch for recovery, if the UE (202) is configured with CFRA, the UE (202) may perform beam selection and if there is CFRA (Contention Free Random Access) resources available for the selected beam. The UE (202) performs random access using the CFRA resources configured for LTM candidate cell. If there is no CFRA resources configured for the selected beam UE MAC may perform contention based random access (CBRA). Alternatively, the UE (202) may select the beam which has CFRA resources configured in LTM candidate configuration. The UE (202) may also perform MAC reset procedure as in TS 38.321 including the reset of timing alignment timers.

In an embodiment, while performing LTM cell switch for recovery, UE MAC discards any timing advance information received from the previous LTM Cell switch command DL MAC CE. This embodiment is applied even when the selected cell is the same LTM candidate cell for which the UE (202) received LTM cell switch command (i.e., the cell indicated by the candidate index of the target such as Target Configuration ID in LTM Cell Switch Command MAC DL CE).

In an embodiment, while performing LTM cell switch for recovery, UE MAC discards any TCI state identifier or UL TCI state identifier received from previous LTM Cell switch command DL MAC CE. This embodiment is applied even when the selected cell is the same LTM candidate cell as the cell for which the UE (202) received LTM cell switch command (i.e. the cell indicated by the candidate index of the target such as Target Configuration ID in LTM Cell Switch Command MAC DL CE).

In an alternative embodiment, while performing LTM cell switch for recovery, UE MAC applies any TCI state identifier or UL TCI state identifier received from previous LTM Cell switch command DL MAC CE when the selected cell is the same LTM candidate cell for which the UE (202) received LTM cell switch command (i.e. the cell indicated by the candidate index of the target such as Target Configuration ID in LTM Cell Switch Command MAC DL CE)

In an embodiment, while performing LTM cell switch for recovery, UE MAC discards any TCI state identifier or UL TCI state identifier received from previous Candidate Cell TCI States Activation/Deactivation MAC CE, for all the candidate cells. This embodiment is applied even when the selected cell is a candidate cell for which it received Candidate Cell TCI States Activation/Deactivation MAC CE.

In an alternative embodiment, while performing LTM cell switch for recovery, UE MAC applies TCI states activation/deactivation for any TCI state identifier or UL TCI state identifier received from previous Candidate Cell TCI States Activation/Deactivation MAC CE when the selected cell is a candidate cell for which it received Candidate Cell TCI States Activation/Deactivation MAC CE.

An example specification update in TS 38.331 is given below.

### 5.3.5.x.6 LTM Cell Switch Execution:

Upon the indication by lower layers that an LTM cell switch procedure is triggered, the UE (202) shall:

Editor's Note: FFS on whether it needs to be clarified that lower layers indicate an LTM candidate cell configuration ID, among other info.

```
1> release/clear all current dedicated radio configuration related to cell group to which the LTM
cell switch procedure is triggered except for the following:
  2> if the LTM cell switch is triggered on the MCG:
    - the MCG C-RNTI;
    - the AS security configurations associated with the master key;
  2> else, if the LTM cell switch is triggered on the SCG:
    - the AS security configurations associated with the secondary key;
    - the radioBearerConfig or radioBearerConfig2;
    - the RLC entity configuration, which include one or more RLC-BearerConfig
IEs;
    - the UE variables VarLTM-Config and VarLTM-UE-Config.
1> reset the MAC entity of this cell group for LTM cell switch;
```

An example specification update for TS 38.321 is given below:

### 5.12 MAC Reset

If a reset of the MAC entity is requested by upper layers or the reset of the MAC entity is triggered due to SCG deactivation as defined in clause 5.29 or the reset of the MAC entity is triggered due to LTM cell switch, the MAC entity shall:

```
1> if the MAC reset is not due to SCG deactivation:
  2> initialize Bj for each logical channel to zero;
1> initialize SBj for each logical channel to zero if Sidelink resource allocation mode 1 is
configured by RRC;
1> if upper layers indicate SCG deactivation and bfd-and-RLM with value true is configured for
the deactivated SCG:
  2> stop (if running) all timers except beamFailureDetectionTimer associated with
PSCell and time AlignmentTimers.
1> else:
  2> stop (if running) all timers, except MBS broadcast DRX timers;
  2> consider all timeAlignmentTimers, inactivePosSRS-TimeAlignmentTimer, and cg-
SDT-TimeAlignmentTimer, if configured, as expired and perform the corresponding actions in
clause 5.2;
1> set the NDIs for all uplink HARQ processes to the value 0;
1> sets the NDIs for all HARQ process IDs to the value 0 for monitoring PDCCH in Sidelink
resource allocation mode 1;
1> stop, if any, ongoing Random Access procedure;
1> discard explicitly signaled contention-free Random Access Resources for 4-step RA type
and 2-step RA type and also for LTM candidate cell, if any;
1> flush Msg3 buffer;
1> flush MSGA buffer;
<additional text skipped>
```

A set of known specification extracts for the LTM with respect to the discussions in 3gpp for TS 38.331 are given below:

The Network may initiate the RRC reconfiguration procedure to the UL (202) in RRC_CONNECTED. The Network applies the procedure as follows:
the ltm-CandidateConfig for LTM on the MCG is included only when AS security has been activated, and SRB2 with at least one DRB are setup and not suspended;
the ltm-CandidateConfig for LTM on the SCG is included only when at least one RLC bearer is setup in SCG.

The UE (202) shall perform the following actions upon reception of the RRC Reconfiguration, or upon execution of the conditional reconfiguration (CHO, CPA or CPC):

```
1> if the RRCReconfiguration message includes the ltm-Config:
  2> perform the LTM configuration procedure as specified in 5.3.5.x.
5.3.5.5 Cell Group configuration
5.3.5.5.1 General
1> if this procedure is initiated due to an LTM cell switch procedure:
  2> if CellGroupConfig contains the ltm-CellSwitchInfo:
    3> apply as the C-RNTI for this cell group the value included in newUE-
Identity within the field ltm-CellSwitchInfo of the LTM candidate cell configuration indicated
by lower layers;
    3> configure lower layers in accordance with the received
spCellConfigCommon within the field ltm-CellSwitchInfo of the LTM candidate cell
configuration indicated by lower layers;
    3> configure lower layers in accordance with the received rach-
ConfigDedicated within the field ltm-CellSwitchInfo of the LTM candidate cell configuration
indicated by lower layers.
5.3.5.8.X T3xx expiry (LTM cell switch failure)
```

The UE (202) shall:

```
1> if T3xx of MCG expires:
  2> release dedicated preambles provided in rach-ConfigDedicated if configured;
  2> release dedicated msgA PUSCH resources provided in rach-ConfigDedicated if
configured;
  2> revert back to the UE configuration used in the source PCell;
  2> initiate the connection re-establishment procedure as specified in clause 5.3.7.
1> else if T3xx of SCG expires:
  2> if MCG transmission is not suspended:
    3> release dedicated preambles provided in rach-ConfigDedicated, if
configured;
    3> release dedicated msgA PUSCH resources provided in rach-
ConfigDedicated, if configured;
    3> initiate the SCG failure information procedure as specified in clause 5.7.3
to report SCG LTM cell switch failure, upon which the RRC reconfiguration procedure ends;
  2> else:
    3> initiate the connection re-establishment procedure as specified in clause
5.3.7;
5.3.5.x LTM configuration and execution
5.3.5.x.1 General
```

The network configures the UE (202) with one or more LTM candidate cell configurations within the LTM-Config IE.

In NR-DC, the U (202) may receive two independent ltm-Config:
an ltm-Config associated with the MCG that is included within an RRCReconfiguration message received via SIB1; and/or
an ltm-Config associated with the SCG that is included within an RRCReconfiguration message either received via SRB3, or, alternatively, embedded in a RRCReconfiguration message received via SRB1.

```
5.3.5.18LTM configuration and execution
5.3.5.18.1 LTM configuration
1> if the received LTM-Config includes the ltm-CandidateToReleaseList:
  2> perform the LTM candidate configuration release as specified in 5.3.5.18.2;
1> if the received LTM-Config includes the ltm-CandidateToAddModList:
  2> perform the LTM candidate configuration addition or modification as specified in
5.3.5.18.3;
```

In this case:
the UE (202) maintains two independent VarLTM-Config, one associated with each ltm-Config;
the UE (202) maintains two independent VarLTM-UE-Config, one associated with each ltm-Config;
the UE (202) independently performs all the procedures in clause 5.3.5.x for each ltm-Config and the associated VarLTM-Config and VarLTM-UE-Config, unless explicitly stated otherwise.

The U3 (202) shall perform the following actions based on the received LTM-Config IE:

```
1> if ltm-ReferenceConfiguration is present within VarLTM-Config:
  2> replace Itm-ReferenceConfiguration within VarLTM-Config with the
received Itm-ReferenceConfiguration within the LTM-Config IE.
  2> for each ltm-CandidateId in VarLTM-Config:
    3> perform the actions to generate a complete LTM configuration as
specified in 5.3.5.x.4;
1> else:
  2> store the received Itm-ReferenceConfiguration in VarLTM-Config, if
present;
1> if the LTM-Config includes the ltm-ServingCellNoResetID:
  2> consider the received Itm-ServingCellNoResetID as the ltm-
ServingCellNoResetID associated with current serving cell for this cell group;
1> if the LTM-Config includes the ltm-CandidateNoResetL2-List:
  2> add the received ltm-CandidateNoResetL2-List to VarLTM-Config;
1> if the LTM-Config includes the ltm-CandidateToAddModList:
  2> perform the LTM candidate cell addition or reconfiguration as specified in
5.3.5.x.3;
5.3.5.x.2 LTM candidate cell release
```

The UE (202) shall:

```
1> for each ltm-CandidateId in the ltm-CandidateToReleaseList:
  2> if the current VarLTM-Config includes an ltm-Candidate with the given
ltm-CandidateId:
    3> remove the entry related to ltm-Candidate from VarLTM-Config;
  2> if the current VarLTM-UE-Config includes a UE-LTM-Candidate with the
given ltm-CandidateId:
    3> remove the entry related to UE-LTM-Candidate from VarLTM-
UE-Config.
5.3.5.x.3 LTM candidate cell addition/modification
```

The UE (202) shall:

```
1> for each ltm-CandidateId in the ltm-CandidateToAddModList:
  2> if the current VarLTM-Config includes an ltm-Candidate with the given
ltm-CandidateId:
    3> replace the ltm-Candidate within VarLTM-Config in accordance
with the received ltm-Candidate;
  2> else:
    3> add the received ltm-Candidate to VarLTM-Config.
  2> perform the actions to generate a complete LTM configuration as specified
in 5.3.5.x.4;
```

NOTE X: It is up to the UE (202) implementation to postpone the generation of a complete LTM configuration as specified in 5.3.5.x.4 until the executing of an LTM cell switch.

### 5.3.5.x.4 Generation of UE LTM Configuration

The purpose of this procedure is for the UE (202) to generate a complete LTM candidate cell configuration to be stored and applied only when an indication of an LTM cell switch is received by lower layers. During the generation of a complete LTM candidate cell configuration, the current configuration of the UE (202) shall not be modified.

The UE (202) shall:

```
1> if not present, store the ltm-CandidateId included in ltm-Candidate within VarLTM-UE-
Config;
1> if ltm-Candidate includes ltm-ConfigComplete;
  2> consider the received Itm-CandidateConfig within Itm-Candidate as a
complete LTM candidate cell configuration;
  2> if ltm-Candidate is already present within VarLTM-UE-Config:
    3> replace the received Itm-CandidateConfig with the one already
present in ue-LTM-Config within VarLTM-UE-Config;
  2> else:
    3> store the received Itm-CandidateConfig in ue-LTM-Config within
VarLTM-UE-Config;
1> else:
  2> generate a complete LTM candidate cell configuration by applying ltm-
CandidateConfig on top of ltm-referenceConfiguration, according to clause 5.3.5.x.5.
  2> if ltm-Candidate is already present within VarLTM-UE-Config:
    3> replace the generated LTM candidate cell configuration with the
one already present in ue-LTM-Config within VarLTM-UE-Config;
  2> else:
    3> store the generated LTM candidate cell configuration in ue-LTM-
Config within VarLTM-UE-Config;
5.3.5.x.5 Handling of fields in LTM reference configuration and LTM candidate cell
configuration
```

Upon the generation of a complete LTM candidate cell configuration by applying an ltm-CandidateConfig on top of an ltm-referenceConfiguration, the UE (202) shall:

```
1> consider the configuration in ltm-referenceConfiguration as the complete LTM candidate
cell configuration;
1> for each Need N field present in ltm-CandidateConfig that releases an element on a list (e.g.,
elementsToReleaseList according to A.3.9):
  2> delete the corresponding element from the complete LTM candidate cell
configuration, if present;
1> for each Need N field present in ltm-CandidateConfig that add or modify an element on a
list (e.g., elementsToAddModList according to A.3.9):
  2> if the corresponding element is already present in the complete LTM
candidate cell configuration:
    3> modify the corresponding element in the complete LTM candidate
cell configuration with the one received in ltm-CandidateConfig;
  2> else:
    3> add the corresponding element in the complete LTM candidate cell
configuration according to the one in ltm-CandidateConfig;
1> for each Need N field present in ltm-CandidateConfig (i.e., that do not release, add, or modify
an element of a list):
  2> if the field is present in the complete LTM candidate cell configuration:
    3> modify the corresponding Need N field in the complete LTM
candidate cell configuration with the one received in ltm-CandidateConfig;
  2> else:
    3> add the Need N field received in Itm-CandidateConfig in the
complete LTM candidate cell configuration;
1> for each Need R field present in ltm-CandidateConfig:
  2> if the field is present in the complete LTM candidate cell configuration:
    3> modify the corresponding Need R field in the complete LTM
candidate cell configuration with the one received in ltm-CandidateConfig;
  2> else:
    3> add the Need R field received in ltm-CandidateConfig in the
complete LTM candidate cell configuration;
1> for each Need N field that is present in the LTM candidate cell configuration but does not
have a corresponding Need N field in ltm-CandidateConfig (i.e., Need N fields that do not
release, add, or modify an element of a list):
  2> remove the corresponding Need N field from the complete LTM candidate
cell configuration;
1> for each Need R field that is present in the LTM candidate cell configuration but does not
have a corresponding Need R field in ltm-CandidateConfig:
  2> remove the corresponding Need R field from the complete LTM candidate
cell configuration;
```

NOTE X: For the handling of all remaining ASN.1 structures, information elements, and fields that are not mentioned in this procedure the UE (202) should follow the general guidelines and principles according to Annex A.

### 5.3.5.x.6 LTM Cell Switch Execution

Upon the indication by lower layers that an LTM cell switch procedure is triggered, the UE (202) shall:

```
1> release/clear all current dedicated radio configuration related to this cell group except for the
following:
  2> if the LTM cell switch is triggered on the MCG:
    - the MCG C-RNTI;
    - the AS security configurations associated with the master key;
  2> else, if the LTM cell switch is triggered on the SCG:
    - the AS security configurations associated with the secondary key;
    - the radioBearerConfig or radioBearerConfig2;
    - the RLC entity configuration, which include one or more RLC-BearerConfig
IEs;
    - the UE variables VarLTM-Config and VarLTM-UE-Config.
1> release/clear all current common radio configuration;
1> use the default values specified in 9.2.3 for timers T310, T311 and constants N310, N311;
1> stop timer T310 for the corresponding SpCell, if running;
1> if this procedure is executed for the MCG:
  2> if timer T316 is running;
    3> stop timer T316;
1> stop timer T312 for the corresponding SpCell, if running;
1> reset the counters N310 and N311;
1> start timer T3xx for this cell group with the timer value set to t3xx, as included within the
field ltm-Timers;
1> apply the default L1 parameter values as specified in corresponding physical layer
specifications;
1> apply the specified BCCH configuration defined in 9.1.1.1 for the target LTM candidate cell;
1> acquire the MIB of the target SpCell for the LTM candidate cell configuration indicated by
lower layers, which is scheduled as specified in TS 38.213 [13], if applicable;
1> reset the MAC entity of this cell group;
1> if the value of field ltm-NoResetID contained within the LTM-Candidate IE related to the
LTM candidate cell configuration identity as received by lower layers is equal to the value of
Itm-ServingCellNoResetID in current serving cell for this cell group:
  2> continue using the current RLC entity in the LTM candidate cell configuration
indicated by lower layers;
  2> replace the value of ltm-ServingCellNoResetID for this cell group with the value
received within ltm-NoResetID;
1> else:
  2>for each RLC-BearerConfig within rlc-BearerToAddModList:
    3> re-establis h the RLC entity as specified in TS 38.322 [4];
  2> for each drb-Identity value included in the drb-ToAddModList that is part of the
current UE configuration and not configured as DAPS bearer:
    3> trigger the PDCP entity of this DRB to perform data recovery as specified
in TS 38.323 [5];
1> continue using the current PDCP entity in the LTM candidate cell configuration indicated by
lower layers;1> apply the LTM configuration in ue-LTM-Config within VarLTM-UE-Config
related to the LTM candidate cell configuration identity as received by lower layers according
to clause 5.3.5.3;
1> if the RRCReconfiguration message including the LTM-Candidate IE related to the LTM
candidate cell configuration identity as received by lower layers was received via SRB1 within
the nr-SCG within mrdc-SecondaryCellGroup (UE in NR-DC):
  2> submit the RRCReconfigurationComplete message via the NR MCG embedded in
NR RRC message ULInformationTransferMRDC as specified in clause 5.7.2a.3;
1> else if RRCReconfiguration message including the LTM-Candidate IE related to the LTM
candidate cell configuration identity as received by lower layers was received via SRB3 (UE in
NR-DC):
  2> submit the RRCReconfigurationComplete message via SRB3 to lower layers for
transmission using the new configuration;
1> else (RRCReconfiguration was received via SRB1):
  2> submit the RRCReconfigurationComplete message to lower layers for transmission
via SRB1 using the new configuration.
```

A set of RRC messages and RRC information elements for supporting LTM, as considered in 3gpp discussions are given below.

```
RRCReconfiguration-v1700-Ies ::= SEQUENCE {
    otherConfig-v1700 OtherConfig-v1700 OPTIONAL, -- Need M
  sl-L2RelayUE-Config-r17 SetupRelease {SL-L2RelayUE-Config-r17 }
OPTIONAL, -- Need M
  sl-L2RemoteUE-Config-r17 SetupRelease{SL-L2RemoteUE-Config-r17 }
OPTIONAL, -- Need M
  dedicatedPagingDelivery-r17 OCTET STRING(CONTAINING Paging)
OPTIONAL, -- Cond PagingRelay
  needForGapNCSG-ConfigNR-r17 SetupRelease{NeedForGapNCSG-ConfigNR-r17}
OPTIONAL, -- Need M
  needForGapNCSG-ConfigEUTRA-r17 SetupRelease {NeedForGapNCSG-ConfigEUTRA-
r17}
OPTIONAL, -- Need M
  musim-GapConfig-r17 SetupRelease {MUSIM-GapConfig-r17}
OPTIONAL, -- Need M
  ul-GapFR2-Config-r17 SetupRelease{ UL-GapFR2-Config-r17 }
OPTIONAL, -- Need M
  scg-State-r17 ENUMERATED { deactivated } OPTIONAL,
-- Need N
  appLayerMeasConfig-r17 AppLayerMeasConfig-r17 OPTIONAL,
-- Need M
  ue-TxTEG-RequestUL-TDOA-Config-r17 SetupRelease {UE-TxTEG-RequestUL-TDOA-
Config-r17}
OPTIONAL, -- Need M
  nonCriticalExtension RRCReconfiguration-v18xy
OPTIONAL
}
RRCReconfiguration-v18xy-Ies ::= SEQUENCE {
  ltm-Config-r18 SetupRelease {LTM-Config-r18} OPTIONAL,
-- Need M
  nonCriticalExtension SEQUENCE { } OPTIONAL
}
-- Serving cell specific MAC and PHY parameters for a SpCell:
SpCellConfig ::= SEQUENCE {
  servCellIndex ServCellIndex OPTIONAL, -- Cond SCG
  reconfigurationWithSync ReconfigurationWithSync OPTIONAL,
-- Cond ReconfWithSync
  rlf-TimersAndConstants SetupRelease { RLF-TimersAndConstants }
OPTIONAL, -- Need M
  rlmInSyncOutOfSyncThreshold ENUMERATED {n1}
OPTIONAL, -- Need S
  spCellConfigDedicated ServingCellConfig OPTIONAL,
-- Need M
  ...,
  [[
  lowMobilityEvaluationConnected-r17 SEQUENCE {
    s-SearchDeltaP-Connected-r17 ENUMERATED {dB3, dB6, dB9, dB12, dB15, spare3,
spare2, spare1},
    t-SearchDeltaP-Connected-r17 ENUMERATED {s5, s10, s20, s30, s60, s120, s180,
s240, s300, spare7, spare6, spare5,
      spare4, spare3, spare2, spare1}
  } OPTIONAL, -- Need R
  goodServingCellEvaluationRLM-r17 GoodServingCellEvaluation-r17
OPTIONAL, -- Need R
  goodServingCellEvaluationBFD-r17 GoodServingCellEvaluation-r17
OPTIONAL, -- Need R
  deactivatedSCG-Config-r17 SetupRelease{DeactivatedSCG-Config-r17 }
OPTIONAL -- Cond SCG-Opt
  ]],
  ltm-CellSwitchInfo-r18 SetupRelease { LTM-CellSwitchInfo-r18 } OPTIONAL
-- Cond LTM-Candidate
  ltm-Timers-r18 SetupRelease { LTM-Timers-r18 } OPTIONAL
-- Cond LTM-Config
  ]]
}
LTM-CellSwitchInfo-r18 ::= SEQUENCE {
  spCellConfigCommon-r18 ServingCellConfigCommon
OPTIONAL, -- Need M
  newUE-Identity-r18 RNTI-Value,
  rach-ConfigDedicated-r18 CHOICE {
    uplink-r18 RACH-ConfigDedicated,
    supplementaryUplink-r18 RACH-ConfigDedicated
  } OPTIONAL, -- Need N}
-- ASN1START
-- TAG-CSI-MEASCONFIG-START
CSI-MeasConfig ::= SEQUENCE {
  nzp-CSI-RS-ResourceToAddModList SEQUENCE (SIZE (1..maxNrofNZP-CSI-RS-
Resources)) OF NZP-CSI-RS-Resource OPTIONAL, -- Need N
  nzp-CSI-RS-ResourceToReleaseList SEQUENCE (SIZE (1..maxNrofNZP-CSI-RS-
Resources)) OF NZP-CSI-RS-ResourceId OPTIONAL, -- Need N
  nzp-CSI-RS-ResourceSetToAddModList SEQUENCE (SIZE (1..maxNrofNZP-CSI-RS-
ResourceSets)) OF NZP-CSI-RS-ResourceSet
OPTIONAL, -- Need N
  nzp-CSI-RS-ResourceSetToReleaseList SEQUENCE (SIZE (1..maxNrofNZP-CSI-RS-
ResourceSets)) OF NZP-CSI-RS-ResourceSetId
OPTIONAL, -- Need N
  csi-IM-ResourceToAddModList SEQUENCE (SIZE (1..maxNrofCSI-IM-Resources))
OF CSI-IM-Resource
OPTIONAL, -- Need N
  csi-IM-ResourceToReleaseList SEQUENCE (SIZE (1..maxNrofCSI-IM-Resources)) OF
CSI-IM-ResourceId OPTIONAL, -- Need N
  csi-IM-ResourceSetToAddModList SEQUENCE (SIZE (1..maxNrofCSI-IM-
ResourceSets)) OF CSI-IM-ResourceSet OPTIONAL, -- Need N
  csi-IM-ResourceSetToReleaseList SEQUENCE (SIZE (1..maxNrofCSI-IM-
ResourceSets)) OF CSI-IM-ResourceSetId OPTIONAL, -- Need N
  csi-SSB-ResourceSetToAddModList SEQUENCE (SIZE (1..maxNrofCSI-SSB-
ResourceSets)) OF CSI-SSB-ResourceSet OPTIONAL, -- Need N
  csi-SSB-ResourceSetToReleaseList SEQUENCE (SIZE (1..maxNrofCSI-SSB-
ResourceSets)) OF CSI-SSB-ResourceSetId OPTIONAL, -- Need N
  csi-ResourceConfigToAddModList SEQUENCE (SIZE (1..maxNrofCSI-
ResourceConfigurations)) OF CSI-ResourceConfig
OPTIONAL, -- Need N
  csi-ResourceConfigToReleaseList SEQUENCE (SIZE (1..maxNrofCSI-
ResourceConfigurations)) OF CSI-ResourceConfigId
OPTIONAL, -- Need N
  csi-ReportConfigToAddModList SEQUENCE (SIZE (1..maxNrofCSI-
ReportConfigurations)) OF CSI-ReportConfig OPTIONAL, -- Need N
  csi-ReportConfigToReleaseList SEQUENCE (SIZE (1..maxNrofCSI-
ReportConfigurations)) OF CSI-ReportConfigId
OPTIONAL, -- Need N
  reportTriggerSize INTEGER (0..6) OPTIONAL,
-- Need M
  aperiodicTriggerStateList SetupRelease { CSI-Aperiodic TriggerStateList }
OPTIONAL, -- Need M
  semiPersistentOnPUSCH-TriggerStateList SetupRelease { CSI-SemiPersistentOnPUSCH-
TriggerStateList }
OPTIONAL, -- Need M
  ...,
  [[
  reportTriggerSizeDCI-0-2-r16 INTEGER (0..6) OPTIONAL
-- Need R
  ]],
  [[
  sCellActivationRS-ConfigToAddModList-r17 SEQUENCE (SIZE
(1..maxNrofSCellActRS-r17)) OF SCellActivationRS-Config-r17 OPTIONAL, -- Need N
  sCellActivationRS-ConfigToReleaseList-r17 SEQUENCE (SIZE (1..maxNrofSCellActRS-
r17)) OF SCellActivationRS-ConfigId-r17 OPTIONAL -- Need N
  ]],
  [[
  ltm-CSI-ReportConfigToAddModList SEQUENCE (SIZE (1..maxNrofCSI-
ReportConfigurations)) OF LTM-CSI-ReportConfig OPTIONAL, -- Need N
  ltm-CSI-ReportConfigToReleaseList SEQUENCE (SIZE (1..maxNrofCSI-
ReportConfigurations)) OF LTM-CSI-ReportConfigId
OPTIONAL, -- Need N
  ]]
}
-- TAG-CSI-MEASCONFIG-STOP
-- ASN1STOP
```

ltm-CellSwitchInfo: This field contains necessary information for the UE (202) to execute an LTM cell switch procedure in case this cell is a LTM candidate cell.

ltm-Timers: Indicates the timer value of T3xx to be used during and LTM cell switch procedure.

ltm-CSI-ReportConfigToAddModList: Configured CSI report settings for LTM as specified in TS 38.xxx [XX].

LTM-Candidate: The field is mandatory present, Need M, if the CellGroupConfig IE is part of ltm-CandidateConfig within ltm-Config. It is absent otherwise.

LTM-Config: This field is mandatory present, Need M, if ltm-Config is included with the RRCReconfiguration message. It is absent otherwise.

### LTM-Config:

The IE LTM-Config is used to provide LTM candidate cell configuration.

### LTM-Config Information Element

```
-- ASN1START
-- TAG-LTM-CONFIG-START
LTM-Config-r18 ::= SEQUENCE {
  ltm-ReferenceConfiguration-r18 OCTET STRING (CONTAINING
RRCReconfiguration),
OPTIONAL, -- Cond FirstLTM-Candidate
  ltm-CandidateToReleaseList-r18 LTM-CandidateToReleaseList-r18
OPTIONAL, -- Need N
  ltm-CandidateToAddModList-r18 LTM-CandidateToAddModList-r18
OPTIONAL, -- Need N
  ltm-ServingCellNoResetID-r18 INTEGER(1.. maxNrofCellsLTM-r18)
OPTIONAL, -- Cond FirstLTM-Only
  ltm-CSI-ResourceConfigToAddModList-r18 SEQUENCE (SIZE (1..maxNrofCSI-
ResourceConfigurations)) OF LTM-CSI-ResourceConfig
OPTIONAL, -- Need N
  ltm-CSI-ResourceConfigToReleaseList-r18 SEQUENCE (SIZE (1..maxNrofCSI-
ResourceConfigurations)) OF LTM-CSI-ResourceConfigId
OPTIONAL, -- Need N
  ...
}
LTM-CandidateToReleaseList-r18 ::= SEQUENCE (SIZE (1..maxNrofCellsLTM-r18)) OF
LTM-CandidateId-r18
OPTIONAL -- Need N
-- TAG-LTM-CONFIG-STOP
-- ASN1STOP
```

Table 1 depicts LTM-CandidateConfig field descriptions.

TABLE 1
LTM-CandidateConfig field descriptions

Itm-CandidateToAddModList
List of LTM candidate cell configurations to add and/or modify.
Itm-CandidateToReleaseList
List of LTM candidate cell configurations to remove.
Itm-CandidateNoResetL2-List
FFS
Itm-ServingCellNoResetID
This field is used by the UE (202) to understand on whether no L2 reset should be performed
for an LTM candidate cell upon an LTM cell switch procedure. If the value of ltm-NoResetID
in an LTM candidate cell is the same as the value of ltm-ServingCellNoResetID in the serving
cell of a cell group, then the UE (202) shall not perform any L2 reset during the LTM cell switch
procedure.
Itm-ReferenceConfiguration
This field includes an RRCReconfiguration message used to configure a reference configuration
for LTM.

Table 2 depicts conditional presence and explanation of LTM candidate.

TABLE 2

| Conditional Presence | Explanation |
|---|---|
| FirstLTM-Candidate | This field is mandatory present upon the first configuration of LTM- |
| | Config which includes at least one LTM candidate cell configuration |
| | where Itm-ConfigComplete is not present. Otherwise, the field is |
| | optionally present, Need M. |
| FirstLTM-Only | This field is mandatory present upon the first configuration of LTM- |
| | Config which includes at least one LTM candidate cell configuration. |
| | Otherwise, the field is absent, Need N. |

### LTM-CandidateId

The IE LTM-CandidateId is used to identify an LTM candidate cell configuration.

| | |
|---|---|
| LTM-CandidateId information element | |
| -- ASN1START | |
| -- TAG-LTM-CANDIDATEID-START | |
| LTM-CandidateId-r18 ::= | INTEGER (1..maxNrofCellsLTM-r18) |
| -- TAG-LTM-CANDIDATEID-STOP | |
| -- ASN1STOP | |
| - LTM-CandidateToAddModList | |

The IE LTM-CandidateToAddModList concerns a list of LTM candidate cell configurations to add or modify.

```
LTM-CandidateToAddModList information element
-- ASN1START
-- TAG-LTM-CANDIDATETOADDMODLIST-START
LTM-CandidateToAddModList-r18 ::= SEQUENCE (SIZE (1..maxNrofCellsLTM-r18)) OF
LTM-Candidate-r18
LTM-Candidate-r18 ::= SEQUENCE {
  ltm-CandidateId-r18 LTM-CandidateId-r18,
  ltm-CandidateConfig-r18 OCTET STRING (CONTAINING
RRCReconfiguration),
  ltm-ConfigComplete-r18 ENUMERATED {true} OPTIONAL,
-- Need R
  ltm-EarlyUlSyncConfig-r18 SetupRelease { EarlyUlSyncConfig-r18 }
OPTIONAL, -- Need M
  ltm-NoResetID-r18 INTEGER (1..maxNrofCellsLTM-r18) OPTIONAL,
-- Need M
  ltm-Candidate-Tci-States-ToAddModList-r18 Candidate-Tci-States-r18
OPTIONAL, -- Need N
  ltm-Candidate-Tci-States-ToReleaseList-r18 Candidate-Tci-StatesId-r18
OPTIONAL, -- Need N ...
}
-- TAG-LTM-CANDIDATETOADDMODLIST-STOP
-- ASN1STOP
```

Table 3 depicts LTM-CandidateToAddModList field descriptions.

TABLE 3
LTM-CandidateToAddModList field descriptions

Itm-CandidateId
This field indicates an LTM candidate cell configuration.
Itm-CandidateConfig
This field includes an RRCReconfiguration message used to configure an LTM candidate cell.
Itm-ConfigComplete
This field indicates whether the LTM candidate cell configuration within ltm-Config is a
complete configuration and thus the UE (202) shall not use the LTM reference configuration
within the field ltm-ReferenceConfiguration.
Itm-NoResetID
This field indicate whether the UE (202) should perform no L2 reset for an LTM candidate cell
upon an LTM cell switch procedure. If the value of ltm-NoResetID in the LTM candidate cell
is the same as the value of ltm-ServingCellNoResetID in the serving cell of a cell group, then
the UE (202) shall not perform any L2 reset during an LTM cell switch procedure.

This field indicate whether the UE (202) should perform no L2 reset for an LTM candidate cell upon an LTM cell switch procedure. If the value of ltm-NoResetID in the LTM candidate cell is the same as the value of ltm-ServingCellNoResetID in the serving cell of a cell group, then the UE (202) shall not perform any L2 reset during an LTM cell switch procedure.

```
Candidate-Tci-States information element
-- ASN1START
-- TAG-CANDIDATE-TCI-STATES-START
Candidate-Tci-States ::= SEQUENCE {
  tci-state <SEQUENCE DEFINING TCI-STATE> OPTIONAL, -- Need M
  ...
}
-- TAG-CANDIDATE-TCI-STATES-STOP
-- ASN1STOP
```

Table 4 depicts Candidate-Tci-States field descriptions

TABLE 4
Candidate-Tci-States field descriptions
tci-state

TCI State for LTM.

### Candidate-Tci-StatesId

The IE Candidate-Tci-StatesId is used to identify a Candidate-Tci-States.

Candidate-Tci-StatesId information element
-- ASN1START
-- TAG-CANDIDATE-TCI-STATESID-START
Candidate-Tci-StatesId ::= INTEGER (0..FFS-1)
-- TAG-LTM-CANDIDATE-TCI-STATESID-STOP
-- ASN1STOP
- LTM-CSI-ReportConfig

The IE LTM-CSI-ReportConfig is used to configure report on the cell in which the LTM-CSI-ReportConfig is included, FFS on the details.

LTM-CSI-ReportConfig information element
-- ASN1START
-- TAG-LTM-CSI-REPORTCONFIG-START
LTM-CSI-ReportConfig ::= SEQUENCE {
CSI Report configuration for LTM
OPTIONAL, -- Need M
...
}
-- TAG-LTM-CSI-REPORTCONFIG-STOP
-- ASN1STOP

LTM-CSI-ReportConfig field descriptions: CSI report configuration for LTM.

### LTM-CSI-ResourceConfigId

The IE LTM-CSI-ReportConfigId is used to identify an LTM-CSI-ReportConfig.

LTM-CSI-ReportConfigId information element
-- ASN1START
-- TAG-LTM-CSI-REPORTCONFIGID-START
LTM-CSI-ReportConfigId ::= INTEGER (0..maxNrofCSI-ReportConfigurations-1)
-- TAG-LTM-CSI-REPORTCONFIGID-STOP
-- ASN1STOP
- LTM-CSI-ResourceConfig

The IE LTM-CSI-ResourceConfig defines a group of one or more CSI resources for an LTM candidate cell configuration.

```
LTM-CSI-ResourceConfig information element
-- ASN1START
-- TAG-LTM-CSI-RESOURCECONFIG-START
LTM-CSI-ResourceConfig ::= SEQUENCE {
  FFS FFS OPTIONAL, -- Need
M
  ...
}
-- TAG-LTM-CSI-RESOURCECONFIG-STOP
-- ASN1STOP
- LTM-CSI-ResourceConfigId
```

The IE LTM-CSI-ResourceConfigId is used to identify an LTM-CSI-ResourceConfig.

LTM-CSI-ResourceConfigId information element
-- ASN1START
-- TAG-LTM-CSI-RESOURCECONFIGID-START
LTM-CSI-ResourceConfigId ::= INTEGER (0..maxNrofCSI-ResourceConfigurations-1)
-- TAG-LTM-CSI-RESOURCECONFIGID-STOP
-- ASN1STOP
- EarlyUlSync-Config

The IE EarlyUlSync-Config is used to configure random access resources for the early UL synchronization procedure.

EarlyULSync-Config information element
--ASN1START
--TAG-EARLYULSYNC-CONFIG-START
EarlySync-Config ::= SEQUENCE {

| | | |
|---|---|---|
| ra-Config | FFS | OPTIONAL, -- |

Need M
...
}
-- TAG-EARLYULSYNC-CONFIG-STOP
-- ASN1STOP

Table 5 depicts EarlyULSync-Config field descriptions

TABLE 5
EarlyULSync-Config field descriptions
ra-Config

Configuration used by the UE (202) to perform the early UL synchronization procedure.

The UE (202) variables for LTM may be defined as below:

7.4 UE variables
- VarLTM-Config

The IE VarLTM-Config is used to store the reference configuration and the LTM candidate cell configurations.

VarLTM-Config UE variable
-- ASN1START
-- TAG-VARLTM-CONFIG-START
VarLTM-Config-r18-IEs ::= SEQUENCE {

| | |
|---|---|
| ltm-ReferenceConfiguration-r18 | OCTET STRING (CONTAINING |

RRCReconfiguration),

| | |
|---|---|
| ltm-CandidateList-r18 | LTM-CandidateList-r18 |

}

LTM-CandidateList-r18 ::= SEQUENCE (SIZE (1..maxNrofCellsLTM-r18)) OF LTM-
Candidate-r18
-- TAG-VARLTM-CONFIG-STOP
-- ASN1STOP
- VarLTM-UE-Config

The JE VarLTM-UE-Config is used to store the generated UE configuration related to the received LTM candidate cell configurations.

VarLTM-UE-Config UE variable
-- ASN1START
-- TAG-VARLTM-CONFIG-START
VarLTM-UE-Config-r18-IEs ::= SEQUENCE {

| | |
|---|---|
| ue-ltm-ConfigCandidateList-r18 | UE-LTM-ConfigCandidateList-r18 |

}
UE-LTM-ConfigCandidateList-r18 ::= SEQUENCE (SIZE (1..maxNrofCellsLTM-r18)) OF
UE-LTM-Candidate-r18
UE-LTM-Candidate-r18 ::= SEQUENCE {

| | |
|---|---|
| ltm-CandidateId-r18 | LTM-CandidateId-r18, |
| ue-LTM-Config-r18 | OCTET STRING, |

}
-- TAG-VARLTM-CONFIG-STOP
-- ASN1STOP

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a base station in a wireless communication system, the method comprising:
determining whether to configure lower layer triggered mobility (LTM) for a master cell group (MCG);
determining whether to configure the LTM for a secondary cell group (SCG); and
transmitting, to a user equipment (UE), a configuration message including at least one of first LTM configuration information for the MCG and second LTM configuration information for the SCG,
wherein the configuration message includes information about at least one channel state information (CSI) resource for configuring at least one candidate cell for the LTM.

2. The method of claim 1, further comprising:
determining whether at least one of an access stratum (AS) security configurations associated with at least one master cell of the MCG is activated, and a signalling radio bearer2 (SRB2) with at least one data radio bearer (DRB) is not suspended,
wherein the configuration message includes the first LTM configuration information for the MCG, in case that the LTM for the MCG is configured, the AS security configurations is activated, and the SRB2 with the at least one DRB is not suspended.

3. The method of claim 1, further comprising:
determining whether at least one radio link control (RLC) bearer is setup in the SCG,
wherein the configuration message includes the second LTM configuration information for the SCG, in case that the LTM for the SCG is configured, the at least one RLC bearer is setup in the SCG.

4. The method of claim 1, wherein the first LTM configuration information and the second LTM configuration information includes at least one of:
a reference configuration,
a reference signal configuration,
a configuration for controlling one or more candidate cells for resetting a layer 2 of the LTM during LTM cell switch execution,
random access resources,
and
a configuration related to transmission configuration indication (TCI) states of the one or more candidate cells.

5. The method of claim 1, further comprising:
determining whether to removing LTM configuration information stored in the UE; and
in case that it is determined to remove the LTM configuration information stored in the UE, transmitting, to the UE, a second configuration message including LTM configuration information set to release.

6. A method of a user equipment (UE) in a wireless communication system, the method comprising:
receiving, from a base station, a configuration message including at least one of first lower layer triggered mobility (LTM) configuration information for a master cell group (MCG) and second LTM configuration information for secondary cell group (SCG); and
storing the at least one of the first LTM configuration information and the second LTM configuration information included in the configuration message,
wherein the first LTM configuration information and the second LTM configuration information include information about at least one channel state information (CSI) resource for configuring at least one candidate cell for the LTM.

7. The method of claim 6,
wherein the configuration message includes the first LTM configuration information for the MCG, in case that at least one of an access stratum (AS) security configurations associated with at least one master cell of the MCG is activated, and a signalling radio bearer2 (SRB2) with at least one data radio bearer (DRB) is not suspended.

8. The method of claim 6,
wherein the configuration message includes the second LTM configuration information for the SCG, in case that at least one radio link control (RLC) bearer is setup in the SCG.

9. The method of claim 6, wherein the first LTM configuration information and the second LTM configuration information includes at least one of:
a reference configuration,
a reference signal configuration,
a configuration for controlling one or more candidate cells for resetting a layer 2 of the LTM during LTM cell switch execution,
random access resources, and
a configuration related to transmission configuration indication (TCI) states of the one or more candidate cells.

10. The method of claim 6, further comprising:
receiving, from the base station, a second configuration message; and
performing an LTM configuration release procedure, in case that LTM configuration information included in the second configuration message is set to release,
wherein the LTM configuration release procedure comprises removing stored configuration information corresponding the LTM configuration information set to release.

11. Abase station in a wireless communication system, the base station comprising:
a transceiver; and
at least one processor coupled to the transceiver and configured to:
determine whether to configure lower layer triggered mobility (LTM) for a master cell group (MCG),
determine whether to configure the LTM for a secondary cell group (SCG), and
transmit, to a user equipment (UE), a configuration message including at least one of first LTM configuration information for the MCG and second LTM configuration information for the SCG,
wherein the configuration message includes information about at least one channel state information (CSI) resource for configuring at least one candidate cell for the LTM.

12. The base station of claim 11, wherein the at least one processor is further configured to:
determine whether at least one of an access stratum (AS) security configurations associated with at least one master cell of the MCG is activated, and a signalling radio bearer2 (SRB2) with at least one data radio bearer (DRB) is not suspended, and
wherein the configuration message includes the first LTM configuration information for the MCG, in case that the LTM for the MCG is configured, the AS security configurations is activated, and the SRB2 with the at least one DRB is not suspended.

13. The base station of claim 11, wherein the at least one processor is further configured to:
determine whether at least one radio link control (RLC) bearer is setup in the SCG, and
wherein the configuration message includes the second LTM configuration information for the SCG, in case that the LTM for the SCG is configured, the at least one RLC bearer is setup in the SCG.

14. The base station of claim 11, wherein the first LTM configuration information and the second LTM configuration information includes at least one of:
a reference configuration,
a reference signal configuration,
a configuration for controlling one or more candidate cells for resetting a layer 2 of the LTM during LTM cell switch execution,
random access resources, and
a configuration related to transmission configuration indication (TCI) states of the one or more candidate cells.

15. The base station of claim 11, wherein the at least one processor is further configured to:
determine whether to removing LTM configuration information stored in the UE, and
in case that it is determined to remove the LTM configuration information stored in the UE, transmit, to the UE, a second configuration message including LTM configuration information set to release.

16. A user equipment (UE) in a wireless communication system, the UE comprising:
a transceiver; and
at least one processor coupled to the transceiver and configured to:
receive, from a base station, a configuration message including at least one of first lower layer triggered mobility (LTM) configuration information for a master cell group (MCG) and second LTM configuration information for secondary cell group (SCG), and
store the at least one of the first LTM configuration information and the second LTM configuration information included in the configuration message,
wherein the first LTM configuration information and the second LTM configuration information include information about at least one channel state information (CSI) resource for configuring at least one candidate cell for the LTM.

17. The UE of claim 16,
wherein the configuration message includes the first LTM configuration information for the MCG, in case that at least one of an access stratum (AS) security configurations associated with at least one master cell of the MCG is activated, and a signalling radio bearer2 (SRB2) with at least one data radio bearer (DRB) is not suspended.

18. The UE of claim 16,
wherein the configuration message includes the second LTM configuration information for the SCG, in case that at least one radio link control (RLC) bearer is setup in the SCG.

19. The UE of claim 16, wherein the first LTM configuration information and the second LTM configuration information includes at least one of:
a reference configuration,
a reference signal configuration,
a configuration for controlling one or more candidate cells for resetting a layer 2 of the LTM during LTM cell switch execution,
random access resources, and
a configuration related to transmission configuration indication (TCI) states of the one or more candidate cells.

20. The UE of claim 16, wherein the at least one processor is further configured to:
receive, from the base station, a second configuration message, and
perform an LTM configuration release procedure, in case that LTM configuration information included in the second configuration message is set to release, and
wherein the LTM configuration release procedure comprises removing stored configuration information corresponding the LTM configuration information set to release.
